(19) United States
(12) Patent Application Publication
(10) Pub. No.: US 2006/0084015 A1
(43) Pub. Date: Apr. 20, 2006

(54) Color diffusion transfer film unit and image-forming method using the color diffusion transfer film unit

(75) Inventor: Shinichi Nakahira, Minami-ashigara-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/248,196

(22) Filed: Oct. 13, 2005

(30) Foreign Application Priority Data
Oct. 14, 2004 (JP) 2004-300397

(51) Int. Cl. G03C 1/46

(52) U.S. Cl. 430/502

(57) ABSTRACT

A color diffusion transfer film unit, containing a light-sensitive sheet, a transparent cover sheet provided and an alkaline processing composition-containing material, in which a silver halide emulsion contained in the light-sensitive sheet is a negative type silver halide emulsion, and in which a total coating amount of the silver halide is 0.9 g/m² or below in terms of silver and from 5 to 10 times greater by number of moles than a total coating amount of a nondiffusing reducing agent contained in color-mixing prevention layers; and an image-forming method using the color diffusion transfer film unit.

### FIELD OF THE INVENTION

The present invention relates to a color diffusion transfer film unit and an image-forming method using the same. More specifically, the present invention relates to a silver halide color diffusion transfer film unit ensured with rapid image formation, reduced color mixing, and formation of deep blacks; and an image-forming method using the same.

### BACKGROUND OF THE INVENTION

Color diffusion transfer film units are classified as an integrated type or a divided type. A representative example of the divided type is a so-called peel-apart type. The color diffusion transfer film unit of the peel-apart type has a light-sensitive sheet and a dye-image-receiving element, which are applied on separate supports. In the peel-apart-type film unit, after an image is exposed to light, the light-sensitive sheet and the dye-image-receiving element are overlapped on each other; a matter containing an alkaline processing composition (alkaline processing composition-containing material) is developed between those members, and then the dye-image-receiving element is peeled apart, to result in exposure of dye images transferred to a dye-image-receiving layer.

The dye images obtained with a color diffusion transfer film unit of the divided type, such as the peel-apart type, is visible directly in a state of being formed in the dye-image-receiving layer made bare with the peeling. Therefore, no reduction in image quality is caused, and excellent image reproduction can be achieved. Also, it can be said that to directly visually observe a film for such excellent color reproduction is a great advantage of a color diffusion transfer film unit of this divided type over a color diffusion transfer film unit of the integrated type as described below, in which an image is observed through a support. However, the color diffusion transfer film unit of the divided type has a disadvantage in processing that the light-sensitive sheet is made to be overlapped on the image-receiving element in a camera, and a disadvantage in handling that, after the dye-receiving element is peeled off, the remaining alkaline processing solution is sticky and is easily stuck to the surroundings.

On the other hand, an integrated-type color diffusion transfer film unit is free of the aforementioned disadvantages in processing and handling, and as such, it is frequently used by general users. The integrated-type color diffusion transfer film unit has, between one transparent support and another support, a dye-image-receiving element, a light-sensitive sheet, a neutralizing timing element, and a rupturable container containing an alkaline processing composition-containing material. The alkaline processing composition-containing material is pressed out of the rupturable container and developed between the image-receiving element and the light-sensitive sheet. The light-sensitive sheet of an integrated-type color diffusion transfer film unit may take either of two configurations: a configuration by which the light-sensitive sheet is applied on the same transparent support as the image-receiving element, and a configuration by which the support to which the light-sensitive sheet is applied is different from the support to which the image-receiving element is applied. Since a white reflecting layer is provided between the image-receiving element and the light-sensitive sheet in the former configuration, and the alkaline processing composition includes a white pigment in the latter configuration, the dye image transferred to the image-receiving layer can be viewed by means of reflected light in both configurations. The integrated-type color diffusion transfer film units are described in many documents, for example Research Disclosure, Vol. 151, No. 15162 (1976), and Photographic Science and Engineering, Vol. 20, No. 4, Jul. 18 (1976).

In either type, the color diffusion transfer film unit has a feature that it is designed to incorporate a light-sensitive material, a processing solution, and a dye-image-receiving layer into one film unit, and thereby to enable on-the-spot processing and immediate viewing of images after shooting by a general user. Accordingly, these light-sensitive materials are required to produce images as fast as possible.

As attempts to expedite the completion of transferred images, yellow-dye-image-forming substances are disclosed in JP-A-6-332131 (“JP-A” means unexamined published Japanese patent application). These substances can enhance the transfer properties of dyes and provide improvements in image formation speed, but the improvements attained are still insufficient. In particular, at low temperatures (e.g. on the order of from 5 to 15° C.), those substances yield almost no improvements in image formation.

Further, attempts to improve operating temperature dependence of the image-forming speed and to increase the speed of image completion by improvements of silver halide grains in a light-sensitive silver halide emulsion layer are disclosed in JP-A-5-307252. In this document, the effects that the use of iodide has on those improvements are described, but the method disclosed therein causes problems, including deterioration in storability, resulting in failure to have satisfactory effects on the improvements.

In addition, JP-A-2000-314950 discloses that a reduction in time required for completion of transferred images, and improvements in the operating temperature dependence, are achieved by the use of silver halide having controlled grain sizes and size distributions as a color diffusion transfer light-sensitive material. And, JP-A-2000-112096 discloses that color diffusion transfer films ensuring rapid image formation and reduced fluctuations in image density can be obtained by incorporation of a nondiffusing reducing agent and a specific water-insoluble compound. Even by the use of those arts, the effects achieved cannot be said to be sufficient. As such, there has been a need for further reduction of image completion time and further improvement of the temperature dependence of completion time.

On the other hand, the recent progress of digital technology has made reverse change of image information from negative to positive or vice versa easy, and thereby it enables users of photographic light-sensitive materials for recording the image information enjoy enhanced freedom to choose between negative type and positive type. In other words, it has become possible to use a negative type silver halide emulsion even in the color diffusion transfer photographic film that hitherto required use of a positive type silver halide emulsion. As a result of my intensive studies, it has been found that a significant increase in image formation speed can be achieved by change of a negative-type emulsion, in the type of a silver halide emulsion used. Although light-sensitive materials using positive type silver halide emulsions have been studied in all of the aforementioned attempts to increase the speed of image formation within the scope of the prior arts, the use of negative type silver halide emulsions makes it possible to attain satisfactory speed of image formation without recourse to those arts. However, it has also been discovered that negative type silver halide emulsions have a problem of serious color-mixing caused by processing, because of their high activity in development. To avoid color-mixing, the amount of a color-mixing inhibitor used is increased, which prolongs image formation time, and reduction in the amount of silver coated causes a contradiction that black depth is impaired in the maximum density, because the maximum color density is lowered. Therefore, production of silver halide color diffusion transfer light-sensitive materials ensured with rapid image formation, reduced color-mixing, and formation of excellent deep blacks was quite difficult by use of the arts hitherto known.

### SUMMARY OF THE INVENTION

The present invention resides in a color diffusion transfer film unit, containing a light-sensitive sheet provided, on a first transparent support, with an image-receiving layer, a white reflecting layer, a light-shielding layer, at least three silver halide emulsion layers different in sensitivity for colors, and at least two color-mixing prevention layers containing a nondiffusing reducing agent, each of which is interposed between two layers among the three silver halide emulsion layers; a transparent cover sheet provided, on a second transparent support, with a neutralizing layer and a neutralizing timing layer; and an alkaline processing composition-containing material to be developed between the light-sensitive sheet and the transparent cover sheet:

in which the silver halide emulsion contained in the light-sensitive sheet is a negative type silver halide emulsion; and

in which a total coating amount of the silver halide is 0.9 g/m² or below in terms of silver and from 5 to 10 times greater by number of moles than a total coating amount of the nondiffusing reducing agent contained in the color-mixing prevention layers.

Further, the present invention resides in an image-forming method using the above color diffusion transfer film unit.

Other and further features and advantages of the invention will appear more fully from the following description.

### DETAILED DESCRIPTION OF THE INVENTION

According to the present invention, there are provided the following means:

(1) A color diffusion transfer film unit, comprising a light-sensitive sheet provided, on a first transparent support, with an image-receiving layer, a white reflecting layer, a light-shielding layer, at least three silver halide emulsion layers different in sensitivity for colors, and at least two color-mixing prevention layers containing a nondiffusing reducing agent, each of which is interposed between two layers among the three silver halide emulsion layers; a transparent cover sheet provided, on a second transparent support, with a neutralizing layer and a neutralizing timing layer; and an alkaline processing composition-containing material to be developed between the light-sensitive sheet and the transparent cover sheet:

wherein the silver halide emulsion contained in the light-sensitive sheet is a negative type silver halide emulsion; and

wherein a total coating amount of the silver halide is 0.9 g/m² or below in terms of silver and from 5 to 10 times greater by number of moles than a total coating amount of the nondiffusing reducing agent contained in the color-mixing prevention layers.

(2) The color diffusion transfer film unit as described in the above item (1),

wherein silver halide emulsion grains in the light-sensitive sheet are tabular grains having an average sphere-equivalent diameter of from 0.2 μm to 0.8 μm and an average aspect ratio of 8 or more.

(3) A method of forming an image,

wherein the color diffusion transfer film unit as described in the above item (1) or (2) is exposed to light by means of an exposure head emitting light at a plurality of wavelength regions in light quantity modulated based on image information.

The color diffusion transfer film unit of the present invention is provided with a light-sensitive sheet, a transparent cover sheet, and an alkaline processing composition-containing material to be developed between these sheets.

[1] Alkaline Processing Composition-Containing Material

The alkaline processing composition-containing material is uniformly developed over the light-sensitive sheet after light exposure, and has both a function of performing development-processing of light-sensitive layers and a function of completely shielding the light-sensitive layers from extraneous light together with a light-shielding layer provided on the backside of the transparent support of the light-sensitive sheet or in the interior of the light-sensitive sheet. Therefore, typical alkaline processing composition-containing materials include, for example, a development accelerator and a development inhibitor for development control, and an antioxidizing agent for prevention of a developer degradation, as well as an alkali, a viscosity-enhancing agent, a light-shielding agent and a developer.

(a) Alkali

The alkali is not particularly limited, as far as it makes the pH of a solution in a range of 12 or more. Examples of the alkali include hydroxides of an alkali metal (e.g., sodium hydroxide, potassium hydroxide, and lithium hydroxide), phosphates of an alkali metal (e.g., potassium phosphate), guanidines, and hydroxides of a quaternary amine (e.g., tetramethylammonium hydroxide). Among these compounds, potassium hydroxide and sodium hydroxide are preferable.

(b) Developing Agent

The developing agent may be any one, as long as it cross-oxidizes a dye-image-forming substance and causes substantially no stains even if it is oxidized. The developing agent may be used either singly or in combinations of two or more, or it can be used in the form of a precursor. As specific examples of the developing agent, aminophenols and pyrazolidinones can be given. Among these compounds, pyrazolidinones are particularly preferable because of decreased occurrence of stains. Given as examples of these pyrazolidinones are 1-phenyl-3-pyrazolidinone, 1-p-tolyl-4,4-dihydroxymethyl-3-pyrazolidinone, 1-(3′-methyl-phenyl)-4-methyl-4-hydroxymethyl-3-pyrazolidinone, 1-phenyl-4-methyl-4-hydroxymethyl-3-pyrazolidinone, 1-p-tolyl-4-methyl-4-hydroxymethyl-3-pyrazolidinone, and the like. The developing agent may be contained in a proper layer of the light-sensitive sheet, or in the alkaline processing composition-containing material.

(c) Light-Shielding Agent

Any materials can be used as the light-shielding agent without imposing particular restrictions thereon, as long as they have a function of shielding light. Examples of the light-shielding agent include carbon black and the decomposable dyes described, for example, in U.S. Pat. No.4,615,966. Of these light-shielding agents, carbon black is preferred. The carbon black has no particular restriction as to its producing method, and may be obtained by an arbitrary producing method. Examples of the producing method of the carbon black include a thermal method and a furnace method, as well as a channel method as described, for example, in Donnel Voet, “Carbon Black”, Marcel Dekker, Inc. (1976).

When carbon black is used as the light-shielding agent, it is preferable that the carbon black is made in advance into an aqueous dispersion. The aqueous dispersion of carbon black is prevailingly used as a black material or a light-shielding material for paint, ink, cosmetics or photographic light-sensitive materials. Preparation of the aqueous dispersion of carbon black is generally performed by adding carbon black to water in which an appropriate dispersant is dissolved, dispersing the carbon black coarsely by means of a coarse dispersion machine (a high-speed-agitation dispersion machine, such as a dissolver described, for example, in Japanese patent application No. 54-36045) until the thus-obtained carbon black comes to have an average particle diameter of about from 10 to 100 μm, and then fining the coarsely dispersed carbon black by means of a fine dispersion machine (such as a sand grinder, a homogenizer and a colloid mill). In these processes, it is possible to prepare an aqueous dispersion of carbon black having an average particle diameter of about from 0.1 to 10 μm. Alternatively, as described in JP-A-58-52362, an aqueous dispersion of carbon black may be prepared by dispersing carbon black into an aqueous solution containing an organic solvent, and then removing the organic solvent.

Examples of preferable dispersing agents include those described in “Bunsan Gijutsu Sogo Shiryoushu” (Comprehensive data collection on dispersion technology, by publishing department of Keiei Kaihatsu Center), pp. 255-257 and pp. 501-539. As an example of a commercially available dispersing agent, can be included Demol N (trade name, manufactured by Kao Corporation).

The kind and/or the amount of the dispersing agent affect the sodium ion content described below. It is preferable that the kind and/or the amount of the dispersing agent be determined so as to satisfy (a) the condition of imparting a sufficient dispersing property to the light-shielding agent and (b) the sodium ion content condition as described below. In order to satisfy both the dispersing property condition and the sodium ion content condition, it is preferable that the mixing proportion of the dispersing agent to the light-shielding agent be from 2 to 100 mass %.

(d) Optical Density

The optical density of the alkaline processing composition-containing material is preferably 47 or more, further preferably 50 or more, and particularly preferably 55 or more. When the optical density of the alkaline processing composition-containing material is too low, it is impossible to obtain sufficient light-shielding effect and spot fogging becomes to easily cause. Accordingly, it is preferable that the mixing amount of the light-shielding agent be determined so as to provide an optical density of 47 or more. Depending on the kind of the light-shielding agent used, the optical density of 47 or more is preferably attainable by making the mixing proportion of the light-shielding agent to be in the range of about from 10 to 40 mass %.

(e) Sodium Ion Content

The sodium ion content in the alkaline processing composition-containing material is preferably 0.4 g/m² or less, when the material is developed. The sodium ion content is more preferably 0.35 g/m² or less, and particularly preferably 0.25 g/m² or below.

The sodium ion content is determined mainly by, as well as the amount of the above-described dispersing agent for the light-shielding agent, the amount of the viscosity-enhancing agent.

As a particularly preferred viscosity-enhancing agent, can be included sodium carboxymethyl cellulose. Sodium carboxymethyl cellulose has sufficient developing property and stability. When polyvinyl alcohol, hydroxyethyl cellulose or carboxymethyl cellulose is used in the form of an alkali metal salt other than sodium salt, as the viscosity-enhancing agent, the sodium ion content can be reduced. However, these alkali metal salts are insufficient in the developing property and the stability, so the singly use thereof is inadequate. Therefore, it is preferable that sodium carboxymethyl cellulose is used mainly as the viscosity-enhancing agent, and that the alkali metal salt, other than sodium salt, of polyvinyl alcohol, hydroxyethyl cellulose or carboxymethyl cellulose is used in combination with the sodium carboxymethyl cellulose.

It is preferable that the etherification degree and addition amount of sodium carboxymethyl cellulose are adjusted to attain a sodium ion content of 0.4 g/m² or below in a developed state. The etherification degree of sodium carboxymethyl cellulose is preferably from 0.5 to 2.7, more preferably from 1.0 to 2.4. The mixing proportion off sodium carboxymethyl cellulose is preferably from 1 to 15 mass %, more preferably from 2 to 10 mass %.

The alkaline processing composition-containing material satisfying the aforesaid optical density condition and sodium ion content condition can exhibit excellent light-shielding property and dye-transferring property, even when it is thinly developed over the light-sensitive sheet. In the present specification, the expression “alkaline processing composition-containing material is thinly developed” means that the alkaline processing composition-containing material is developed in a thickness of 10 to 80 μm over the light-sensitive sheet. The developed thickness is preferably from 10 to 60 μm, more preferably from 20 to 50 μm.

[2] Light-Sensitive Sheet

(a) First Transparent Support

The support of the light-sensitive sheet may be any of substances usually used as supports of photographic light-sensitive materials. The support of the integrated-type color diffusion transfer film unit is required to be transparent. Further, the support surface is preferably smooth. Examples of such a support substance include cellulose acetate, polystyrene, polyethylene terephthalate and polycarbonate. The support preferably contains a minute amount of a dye or pigment such as titanium oxide, to prevent light-piping. The thickness of the support of the light-sensitive sheet is preferably 25 to 350 μm, more preferably 50 to 210 μm, and particularly preferably 70 to 150 μm. On the front side of the support, an undercoat (subbing) layer is preferably provided. A curl-balancing layer, or an oxygen-shielding layer may be applied to the backside of the support according to the need. The oxygen-shielding layer can be provided by reference to the descriptions in JP-A-56-78833, except at the points featured by the present invention.

(b) Image-Receiving Layer

The image-receiving layer (dye-image-receiving layer) of the light-sensitive sheet contains a mordant and a hydrophilic colloid. The image-receiving layer may be a single layer or may have a multilayer constitution, in which layers having different mordant powers are coated such that they are overlapped on each other. The image-receiving layers of the single-layer type and the multilayer type can be provided by reference to the descriptions in JP-A-61-252551, except at the points featured by the present invention.

As the mordant, a polymer mordant is preferable. Preferred examples of the polymer mordant include polymers containing a secondary and/or tertiary amino group, polymers having a nitrogen-containing heterocyclic portion, and polymers containing a quaternary cation, and those having a molecular weight of preferably 5,000 or more, and particularly preferably 10,000 or more. The amount of the mordant to be applied is generally 0.5 to 10 g/m², preferably 1 to 5 g/m², and particularly preferably 2 to 4 g/m².

Examples of the hydrophilic colloid include a gelatin, polyvinyl alcohol, polyacrylantide and polyvinylpyrrolidone, and the hydrophilic colloid is preferably the gelatin.

The image-receiving layer may contain an anti-fading agent. The anti-fading agent is not particularly limited, but those as described in JP-A-62-30620, JP-A-62-30621, and JP-A-62-215272, can be used as the anti-fading agent.

The thickness of the image-receiving layer may be the same as those of general color diffusion transfer film units.

(c) White Reflecting Layer

The white reflecting layer of the light-sensitive sheet forms a white background of a color image. The white reflecting layer generally contains a white pigment and a hydrophilic binder.

The whiteness of the white reflecting layer varies depending on the type of the pigment, the mixing ratio of the pigment and the binder, and the amount of the pigment to be applied. When titanium dioxide is used as the white pigment, the titanium dioxide is contained in an amount of generally 5 to 40 g/m², and preferably 10 to 25 g/m².

The white reflecting layer preferably has a light reflectance of 70% or more, and more preferably has a light reflectance of 78 to 85% for light having a wavelength of 540 nm

As the white pigment, barium sulfate, zinc oxide, barium stearate, silver flakes, silicates, alumina, zirconium oxide, sodium zirconium sulfate, kaolin, mica, titanium dioxide, and the like can be included. Further, non-filming polymer particles made of styrene or the like can also be used as the white pigment. Among these, titanium dioxide is preferably used, and rutile type titanium dioxide is particularly preferably used. The white pigment may be used singly or in combination with two or more thereof. The use of two or more types of the white pigments makes it easier to adjust the reflectance of the white reflecting layer to a preferable value.

As the white pigment, those surface-treated using alumina, silica, zinc oxide, or the like are preferable. In addition, those surface-treated to an extent of 5% or more in amount are more preferable. The white reflecting layer containing a surface-treated white pigment has a high reflectance.

Examples of commercially available titanium dioxide include those described in Research Disclosure (which is also referred to as RD, hereinafter) No. 15162, besides Ti-pure R931 (trade name) manufactured by Du Pont K.K.

Examples of the hydrophilic binder include an alkali-penetrative polymer matrix, such as a gelatin and polyvinyl alcohol, and a cellulose derivative, such as hydroxyethyl cellulose and carboxymethyl cellulose. When the binder is the gelatin, the mass ratio of the white pigment to the gelatin is generally 1/1 to 20/1, and preferably 5/1 to 10/1.

The white reflecting layer preferably contains an anti-fading agent. The anti-fading agent is not particularly limited, but those as described in JP-B-62-30620 (“JP-B” means examined Japanese patent publication) and JP-B-62-30621 can be used as the anti-fading agent.

(d) Light-Shielding Layer

The light-shielding layer is provided between the white reflecting layer and the light-sensitive layer. The light-shielding layer contains a light-shielding agent and a hydrophilic binder.

The light-shielding agent may be any of the light-shielding agents recited in the foregoing section [1](c) (the light-shielding agent of the alkaline processing composition-containing material). The amount of the light-shielding agent to be contained is dependent on the sensitivity of the light-sensitive material to be shielded, but the amount is preferably about from 5 to 10 in terms of optical density in general.

As the binder of the light-shielding agent, any binder may be used as far as it can disperse the light-shielding agent, such as carbon black. As a preferred binder, gelatin can be included.

The thickness of the light-shielding layer is not particularly limited, as far as the light-shielding layer can sufficiently achieve its light-shielding effect and does not render the light-sensitive sheet too thick.

(e) Light-Sensitive Layer

The light-sensitive layer is provided adjacent to the light-shielding layer, and contains a dye-image-forming compound and a silver halide emulsion. The light-sensitive layer may be made up of multiple layers including a silver halide emulsion layer and a dye-image-forming compound layer, or may be a single layer containing both a silver halide emulsion and a dye-image-forming compound. The following are descriptions of the light-sensitive layer having a multilayer structure, and the same goes for the light-sensitive layer having a single-layer structure.

(1) Dye-Image-Forming Compound

As the dye-image-forming compound, can be included a yellow-dye-forming compound, a magenta-dye-forming compound and a cyan-dye-forming compound.

Examples of the yellow-dye-forming compound are described in U.S. Pat. No. 3,597,200, U.S. Pat. No. 3,309,199, U.S. Pat. No. 4,013,633, U.S. Pat. No. 4,245,028, U.S. Pat. No. 4,156,609, U.S. Pat. No. 4,139,383, U.S. Pat. No. 4,195,992, U.S. Pat. No. 4,148,641, U.S. Pat. No. 4,148,643, and U.S. Pat. No. 4,336,322; JP-A-51-114930, JP-A-56-71072, and Research Disclosures No. 17630 (1978) and No. 16475 (1977).

Examples of the magenta-dye-forming compound are described in U.S. Pat. No. 3,453,107, U.S. Pat. No. 3,544,545, U.S. Pat. No. 3,932,380, U.S. Pat. No. 3,931,144, U.S. Pat. No. 3,932,308, No. 3,954,476, U.S. Pat. No. 4,233,237, U.S. Pat. No. 4,255,509, U.S. Pat. No. 4,250,246, U.S. Pat. No. 4,142,891, U.S. Pat. No. 4,207,104, and U.S. Pat. No. 4,287,292; JP-A-52-106727, JP-A-53-23628, JP-A-55-36804, JP-A-56-73057, JP-A-56-71060, JP-A-55-134, JP-A-7-120901, JP-A-8-286343, JP-A-8-286344, and JP-A-8-292537.

Examples of the cyan-dye-forming compound are described in U.S. Pat. No. 3,482,972, U.S. Pat. No. 3,929,760, U.S. Pat. No. 4,013,635, U.S. Pat. No. 4,268,625, U.S. Pat. No. 4,171,220, U.S. Pat. No. 4,242,435, U.S. Pat. No. 4,142,891, U.S. Pat. No. 4,195,994, U.S. Pat. No. 4,147,544, and U.S. Pat. No. 4,148,642; U.K. Patent No. 1,551,138; JP-A-54-99431, JP-A-52-8827, JP-A-53-47823, JP-A-53-143323, JP-A-54-99431, and JP-A-56-71061; European Patents (EP) No. 53,037 and No. 53,040; and Research Disclosures No. 17,630 (1978) and No. 16,475 (1977).

Dye-image-forming compounds, which each form a dye upon coupling, may be used. Examples of the dye-image-forming compounds, which each form a dye upon coupling, are described in JP-A-8-286340, JP-A-9-152705, and Japanese Patent Applications No. 8-357190, No. 8-357191, and No. 9-117529.

A positive type dye-image-forming compound may also be used. Examples the positive type dye-image-forming compound are described in JP-A-4-156542, JP-A-4-155332, JP-A-4-172344, JP-A-4-172450, JP-A-4-318844, JP-A-4-356046, JP-A-5-45824, JP-A-5-45825, JP-A-5-53279, JP-A-5-107710, JP-A-5-241302, JP-A-5-107708, JP-A-5-232659, and U.S. Pat. No. 5,192,649. It is preferable that the positive type dye-image-forming compound is used in combination with the negative type silver halide emulsion as described below.

The positive type dye-image-forming compound can be dispersed by a method described in JP-A-62-215272, pp. 144-146. Also, the dispersion of the compound may contain a compound described in JP-A-62-215272, pp. 137-144. As specific examples of these dye-image-forming compounds, the following compounds can be given. “Dye” in the following compounds represents a dye group, a dye group that is temporarily short-waved, or a dye precursor group. 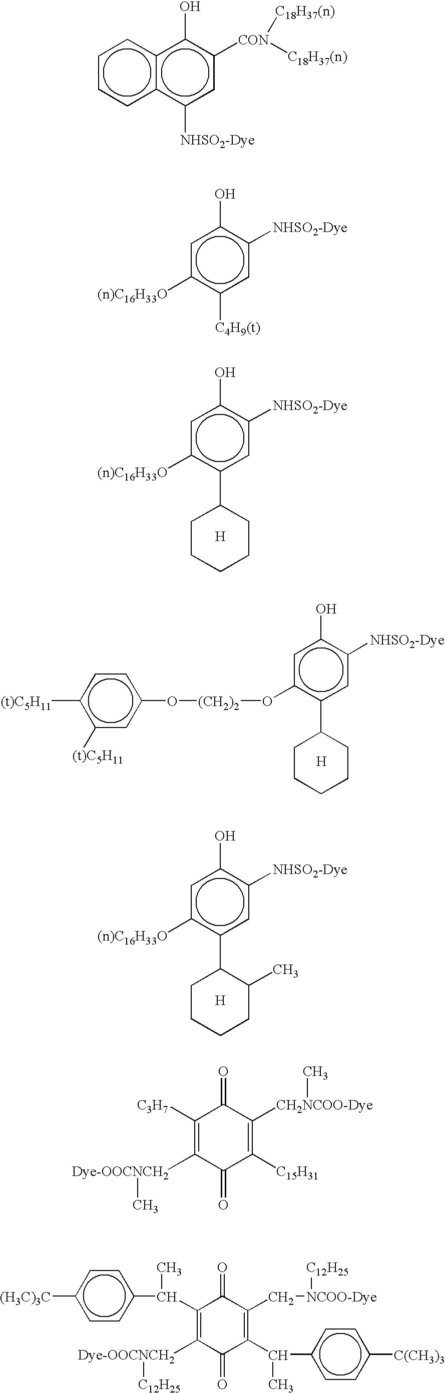 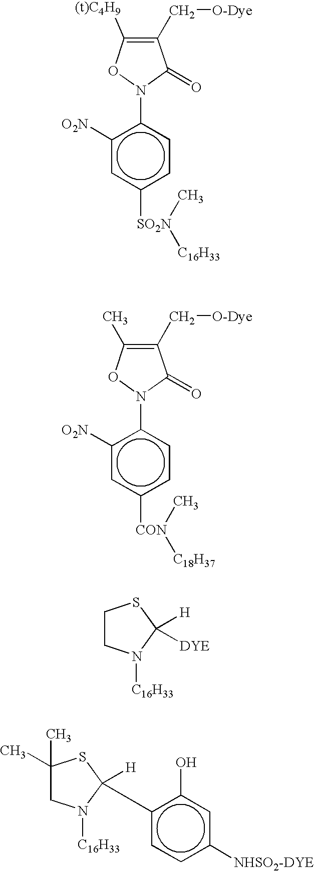
(2) Silver Halide Emulsion

The silver halide emulsion may be made of any of silver chloride, silver bromide, silver iodobromide, silver chlorobromide, silver chloroiodide and silver chloroiodobromide. However, the silver halide emulsion for use in the present invention is required to be a negative type silver halide emulsion, which forms a latent image mainly on the surface of silver halide grains. Utilization of the negative type emulsions makes it possible, for the first time, to achieve a sufficiently color formation density, despite a reduction in coating amount of silver.

The negative type emulsion may be a so-called core-shell emulsion, wherein the grain inside and the grain surface layer have different phases, and may have a structure joined epitaxially. The silver halide emulsion may be a monodisperse or multidisperse emulsion. A technique may be used wherein the gradation is adjusted by mixing monodisperse emulsions, as described in JP-A-1-167743 or JP-A-4-223463.

The crystal habit of the silver halide grains may be any of regular crystals, such as cubic crystals, octahedral crystals and tetradecahedral crystals; irregular crystals, such as spherical crystals and tabular crystals having a high aspect ratio; crystals having crystal defects, such as twin planes, composite crystals of these, or others. However, in the present invention, tabular grains are particularly preferable.

When the silver halide grains for use in the present invention are tabular grains, an aspect ratio of the tabular grains is preferably 8 or more, more preferably 10 or more. With respect to the silver halide grains for use in the present invention, it is preferable that the proportion of tabular grains having an aspect ratio of 8 or more accounts for 50% or more in terms of the total projected area of all the silver halide grains (that is, the average aspect ratio is 8 or more), and it is more preferable that the proportion of tabular grains having an aspect ratio of 10 or more accounts for 50% or more in terms of the total projected area of all the silver halide grains. Making a comparison between grains having the same sphere-equivalent diameter, it is possible to reduce the density drop resulting from the reduction in coating amount of silver, by the use of tabular grains having the higher aspect ratio as the silver halide grains. The aspect ratio of tabular grains used has no upper limit, but an extremely high aspect ratio is responsible for detrimental effects of suppressing diffusion of ingredients of a processing solution and dyes during the processing. Therefore, it is preferable that the aspect ratio is 20 or less.

The grain size of the silver halide grains for use in the present invention is preferably 0.8 μm or less, further preferably 0.7 μm or less, and more preferably 0.6 μm or less, based on an average sphere-equivalent diameter. When the grains have the same crystal form, it is possible to reduce the density drop resulting from the reduction in coating amount of silver, by the use of silver halide grains smaller in size. The grain sizes of silver halide grains used have no lower limit, but an extremely small size causes detriments, such a reduction in sensitivity of the light-sensitive element and a retardation of development due to increase in coating amounts of sensitizing dyes, antifoggants and the like to be adsorbed to the grain surface. Therefore, it is preferable that the setting of the grain size be made within a range that such detriments are not significant. Specifically, the grain size of the silver halide grains for use in the present invention is preferably 0.15 μm or more, far preferably 0.2 μm or more, and farther preferably 0.3 μm or more, based on the average sphere-equivalent diameter.

Examples of other silver halide emulsions include ones prepared by methods described, for example, in U.S. Pat. No. 4,500,626, column 50; U.S. Pat. No. 4,628,021, RD No. 17,029 (1978), RD No. 17,643 (December 1978), pages 22 to 23; RD No. 18,716 (November 1979), page 648; RD No. 307,105 (November 1989), pages 863 to 865; JP-A-62-253159, JP-A-64-13546, JP-A-2-236546, and JP-A-3-110555; by P. Glatlkides in Chemie et Phisique Photographique, Paul Montel (1967); by G. F. Duffin in Photographic Emulsion Chemistry, Focal Press, 1966; and by V. L. Zelikman et al., in Making and Coating Photographic Emulsion, Focal Press, 1964.

The light-sensitive silver halide emulsion is generally a chemically-sensitized silver halide emulsion. To chemically sensitize the light-sensitive silver halide emulsion, known sensitization methods for emulsions in ordinary light-sensitive materials, for example, a chalcogen sensitization method, such as a sulfur sensitization method, a selenium sensitization method, and a tellurium sensitization; a noble metal sensitization method, wherein gold, platinum or palladium is used; and a reduction sensitization method, can be used alone or in combination (e.g. JP-A-3-110555 and JP-A-5-241267). These chemical sensitizations can be carried out in the presence of a nitrogen-containing heterocyclic compound (JP-A-62-253159). Further, an antifoggant can be added after the completion of the chemical sensitization. Specifically, methods described in JP-A-5-45833 and JP-A-62-40446 can be used. When the nitrogen-containing heterocyclic compound having a mercapto group as described in JP-A-62-40446 is used, the compound is preferably added after the completion of the chemical sensitization of the light-sensitive silver halide emulsion.

At the time of the chemical sensitization, the pH is preferably 5.3 to 10.5, and more preferably 5.5 to 8.5, and the pAg is preferably 6.0 to 10.5, and more preferably 6.8 to 9.0.

In the present invention, the total coating amount of the light-sensitive silver halide is 0.9 g/m² or less, preferably 0.8 mg/m² or less, and further preferably 0.7 g/m² or less, in terms of silver. The coating amount of silver halide in the present invention has no particular lower limit, but an extremely small coating amount of silver halide causes a reduction in color formation density. So it is required that the coating amount of silver halide be chosen from a range such that the problem presents no problem. Specifically, it is preferable that the coating amount of silver halide is 0.2 g/m² or above.

In the process for preparing the light-sensitive silver halide emulsion, so-called desalting, for removing excess salts, is preferably carried out. As a means for attaining it, the noodle water-washing method, which is carried out with the gelatin gelled, can be used, and also the sedimentation method, in which an inorganic salt comprising polyvalent anions (e.g. sodium sulfate), an anionic surfactant, an anionic polymer (e.g. sodium polystyrenesulfonate), or a gelatin derivative (e.g. an aliphatic-acylated gelatin, an aromatic-acylated gelatin, and an aromatic-carbamoylated gelatin) is employed, can be used, with the sedimentation method preferred.

The light-sensitive silver halide emulsion may contain a heavy metal, such as iridium, rhodium, platinum, cadmium, zinc, thallium, lead, iron, and osmium. These compounds may be used either singly or in combinations of two or more. The amount to be added varies depending on the purpose of the application; but the amount is generally about from 10⁻⁹ to 10⁻³ mol, per mol of the silver halide. The heavy metal may be dispersed uniformly in the grains, or they may be localized in the grain inside or on the surface of the grains. Specifically, the heavy metal-containing emulsions described, for example, in JP-A-2-236542, JP-A-1-116637, and JP-A-5-181246 are preferably used.

In the step for forming grains of the light-sensitive silver halide emulsion, as a silver halide solvent, for example, a rhodanate, ammonia, a tetrasubstituted thioether compound, an organic thioether derivative described in JP-B-47-11386, or a sulfur-containing compound described in JP-A-53-144319 can be used.

As other conditions employed to prepare the emulsion in the present invention, the description, for example, by P Glafkides in “Chemie et Phisique Photographique,” Paul Montel, 1967; by G. F. Duffin in “Photographic Emulsion Chemistry,” Focal Press, 1966; or by V. L. Zelikman et al. in “Making and Coating Photographic Emulsion,” Focal Press, 1964, can be referred to. That is, any of the acid process, the neutral process, and the ammonia process can be used; and to react a soluble silver salt with a soluble halogen salt, any of the single-jet method, the double-jet method, and a combination thereof can be used. To obtain monodispersed emulsion, the double-jet method is preferably used. A reverse mixing method wherein grains are formed in the presence of excess silver ions can also be used. As one type of the double-jet method, a method wherein pAg in the liquid phase, in which a silver halide will be formed, is kept constant, that is, the so-called controlled double-jet method, can also be used.

Further, to quicken the growth of the grains, the concentrations, the amounts, and the addition speeds of the silver salt and the silver halide to be added may be increased (e.g. JP-A-55-142329, JP-A-55-158124, and U.S. Pat. No. 3,650,757). As the method of stirring the reaction liquid, any of known methods may be used. The temperature and the pH of the reaction liquid during the formation of the silver halide grains may be set arbitrarily to meet the purpose. Preferably the pH range is 2.3 to 8.5, and more preferably 2.5 to 7.5.

A spectral sensitizing dye may be used in combination with the silver halide emulsion for use in the present invention. Specific examples of the spectral sensitizing dye are described in JP-A-59-180550, JP-A-60-140335, RD No. 17029, and U.S. Pat. Nos. 1,846,300, U.S. Pat. No. 2,078,233, No. 2,089,129, U.S. Pat. No. 2,165,338, U.S. Pat. No. 2,231,658, U.S. Pat. No. 2,917,516, U.S. Pat. No. 3,352,857, U.S. Pat. No. 3,411,916, U.S. Pat. No. 2,295,276, U.S. Pat. No. 2,481,698, U.S. Pat. No. 2,688,545, U.S. Pat. No. 2,921,067, U.S. Pat. No. 3,282,933, U.S. Pat. No. 3,397,060, U.S. Pat. No. 3,660,103, U.S. Pat. No. 3,335,010, U.S. Pat. No. 3,352,680, U.S. Pat. No. 3,384,486, U.S. Pat. No. 3,623,881, U.S. Pat. No. 3,718,470, and U.S. Pat. No. 4,025,349.

(3) Constitution of Light-Sensitive Sheet

A light-sensitive sheet for use in the present invention has at least three silver halide emulsion layers different in sensitivity for colors from each other, and at least two color-mixing prevention layers containing a nondiffusing reducing agent, each of which is interposed between two layers among the three silver halide emulsion layers.

For conferring different sensitivities for colors upon the at least three silver halide emulsion layers, respectively, the use of the foregoing spectral sensitizing dyes having a different absorption-wavelength distribution from each other is preferable and effective.

In conferring different sensitivities for colors upon silver halide emulsions in the present invention, it is preferable that overlaps between spectral sensitivity distributions of the silver halide emulsions are made as little as possible. However, there is no need to perfectly separate the spectral sensitivity distributions from one another. When the at least three silver halide emulsion layers provided in the present invention bear a relation that the sensitivity of any one of the silver halide emulsions at a specific wavelength is at least twice as high as the sensitivities of at least two others of the silver halide emulsions at that wavelength, the former layer can be regarded as different in sensitivity for colors from the latter layers. As to the sensitivity relation among the at least three silver halide emulsion layers in the present invention, a relation that the sensitivity of any one of the silver halide emulsions at a specific wavelength is at least 5 times, especially at least 10 times, as high as the sensitivities of at least two others of the silver halide emulsions at that wavelength is preferred. There is no particular restriction as to the specific wavelength at which the foregoing relation holds, so a specific wavelength may be chosen from a visible region, a ultraviolet region or a infrared region. However, it is preferable that the silver halide emulsions of the at least three silver halide emulsion layers for use in the present invention are chosen from silver halide emulsions having their sensitivities for any one of blue light, green light, red light and infrared regions.

The emulsion and the dye-image-forming compound may be contained in separate layers, or they may be incorporated in the same layer. When the applied dye-image-forming compound has absorption at a spectral sensitivity region of the emulsion used in combination, the dye-image-forming compound and the emulsion are preferably contained in separate layers.

The emulsion layer may consist of a plurality of emulsions having different sensitivities, and further an optional layer may be formed between the emulsion layer and the dye-image-forming compound layer. For example, a layer containing a nucleating development accelerator, as described in JP-A-60-173541, or a bulkhead layer as described in JP-B-60-15267, can be formed to raise the density of a color image, and also a reflecting layer can be formed to improve the sensitivity of the light-sensitive sheet. The reflecting layer is a layer generally containing a white pigment and a hydrophilic binder. The white pigment is preferably titanium oxide and the hydrophilic binder is preferably a gelatin. The amount of titanium oxide to be applied is preferably 0.1 g/m² to 8 g/m², and more preferably 0.2 g/m² to 4 g/m². Examples of the reflecting layer are described in JP-A-60-91354.

In the case of a multilayer-structured light-sensitive layer, a combination unit of a blue-sensitive emulsion, a combination unit of a green-sensitive emulsion, and a combination unit of a red-sensitive emulsion are arranged in order, from the exposure side. An arbitrary optional layer may be provided as required between each emulsion layer units, respectively.

(4) Color-Mixing Prevention Layer

In the present invention, in order to prevent developmental effects on some emulsion layer from adversely affecting other emulsion layer units, it is required that a color-mixing prevention layer containing a nondiffusing reducing agent be interposed between two emulsion layers. The light-sensitive sheet for use in the present invention is required to have at least three emulsion layers, so at least two color-mixing prevention layers are required in the light-sensitive sheet, because at least one color-mixing prevention layer is required between each pair of two emulsion layers.

As the nondiffusing reducing agent contained in each color-mixing prevention layer for use in the present invention, any of known compounds can be preferably used.

For example, high-molecular weight redox compounds described in JP-A-5-333501; phenidone- or hydrazine-series compounds as described in WO 98/33760 pamphlet and U.S. Pat. No. 4,923,787 and the like; and redox compounds described in German Patent Application Publication No. 19618786A1, European Patent Application Publication Nos. 839623A1 and 842975A1, German Patent Application Publication No. 19806846A1, French Patent Application Publication No. 2760460A1, and the like, are also preferably used. In addition, lactones as described in JP-A-2000-122243 are also preferably used.

It is especially preferable that the nondiffusing reducing agent used in each color-mixing prevention layer for use in the present invention is selected from nondiffusing hydroquinone, sulfonamidophenol and sulfonamidonaphthol derivatives and lactones. Among these, nondiffusing hydroquinone derivatives are preferable, and dialkylhydroquinone derivatives are more preferable. The alkyl groups herein include substituted or unsubstituted alkyl groups, and have no particular restriction as to their substituents so far as they do not impair nondiffusing properties of the compound. Examples of such substituents include an aryl group, an acyl group, an alkoxycarbonyl group and an aryloxycarbonyl group. The total number of carbon atoms in the dialkyl moiety is preferably at least 12, more preferably at least 16.

The molecular weight of the nondiffusing reducing agent (color-mixing inhibitor) for use in the present invention is preferably 350 or above, more preferably 390 or above, and most preferably 500 or above. When the color-mixing inhibitor is a polymer, the molecular weight thereof is expressed in terms of the number average molecular weight. No particular upper limit is set on the molecular weight of the nondiffusing reducing agent when the nondiffusing reducing agent is the polymer. When the nondiffusing reducing agent is a compound other than the polymer, the upper limit to the molecular weight thereof is preferably about 1,000 or below. The optimum amount of the nondiffusing reducing agent contained in the at least two color-mixing prevention layers, each of which is interposed between the silver halide emulsion layers, varies depending on the coating amount, grain shape and grain size of the silver halide emulsion used and the intended maximum color formation density. However, too large an amount of the nondiffusing reducing agent causes reduction in color formation density and delay in image formation, while too small an amount of the nondiffusing reducing agent results in impure hues of a formed color. Therefore, it is required that the amount of the nondiffusing reducing agent used be determined with consideration given to those factors. The present inventor has found that the reduction of color formation density resulting from reduction in coating amount of silver can be suppressed effectively by setting the ratio of the coating amount of silver halide to the coating amount of the nondiffusing reducing agent within a specified range, and further by using the negative silver halide emulsion as the silver halide emulsion in a specified amount. In the present invention, the total coating amount of silver halide is from 5 to 10 times greater, preferably from 6 to 8 times greater, by number of moles than the total coating amount of the nondiffusing reducing agent contained in the color-mixing prevention layers. Expressed in number of moles, the total coating amount of the nondiffusing reducing agent is preferably from 0.5 to 1.5 mmol/m², more preferably from 0.8 to 1.2 mmol/m².

Examples of the nondiffusing reducing agent that can be used in the present invention are illustrated below, but these examples should not be construed as limiting the scope of the present invention.

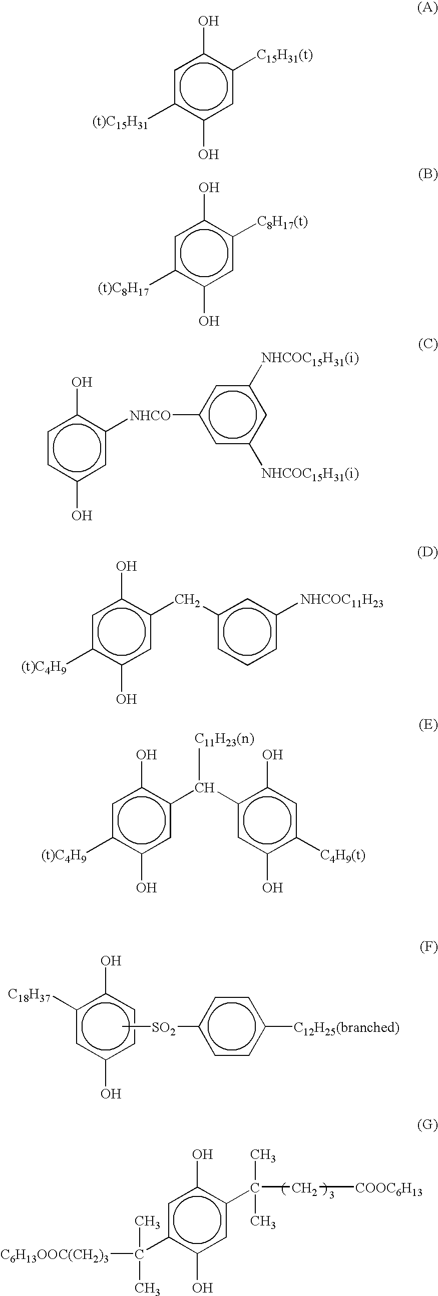

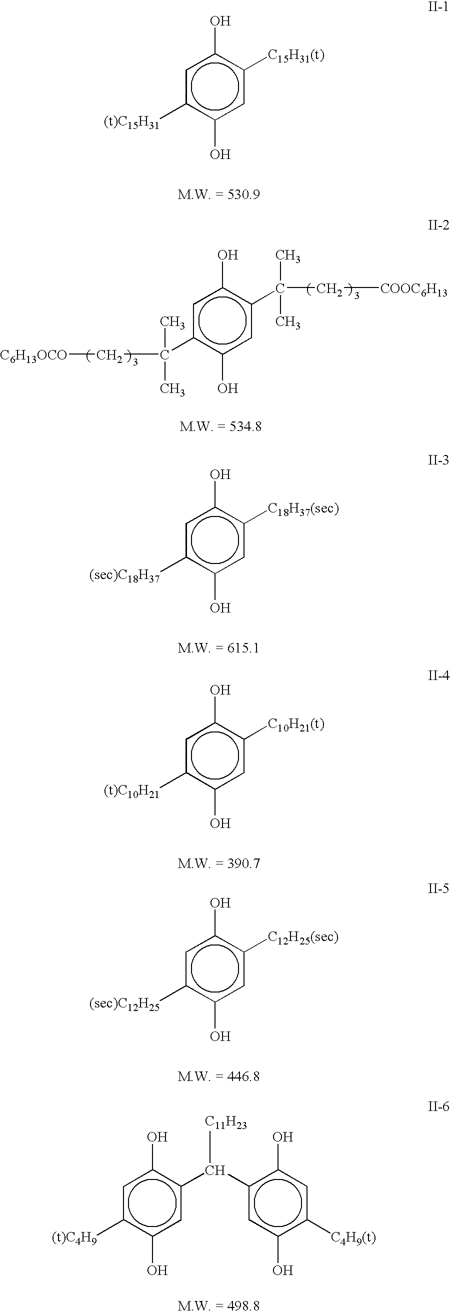

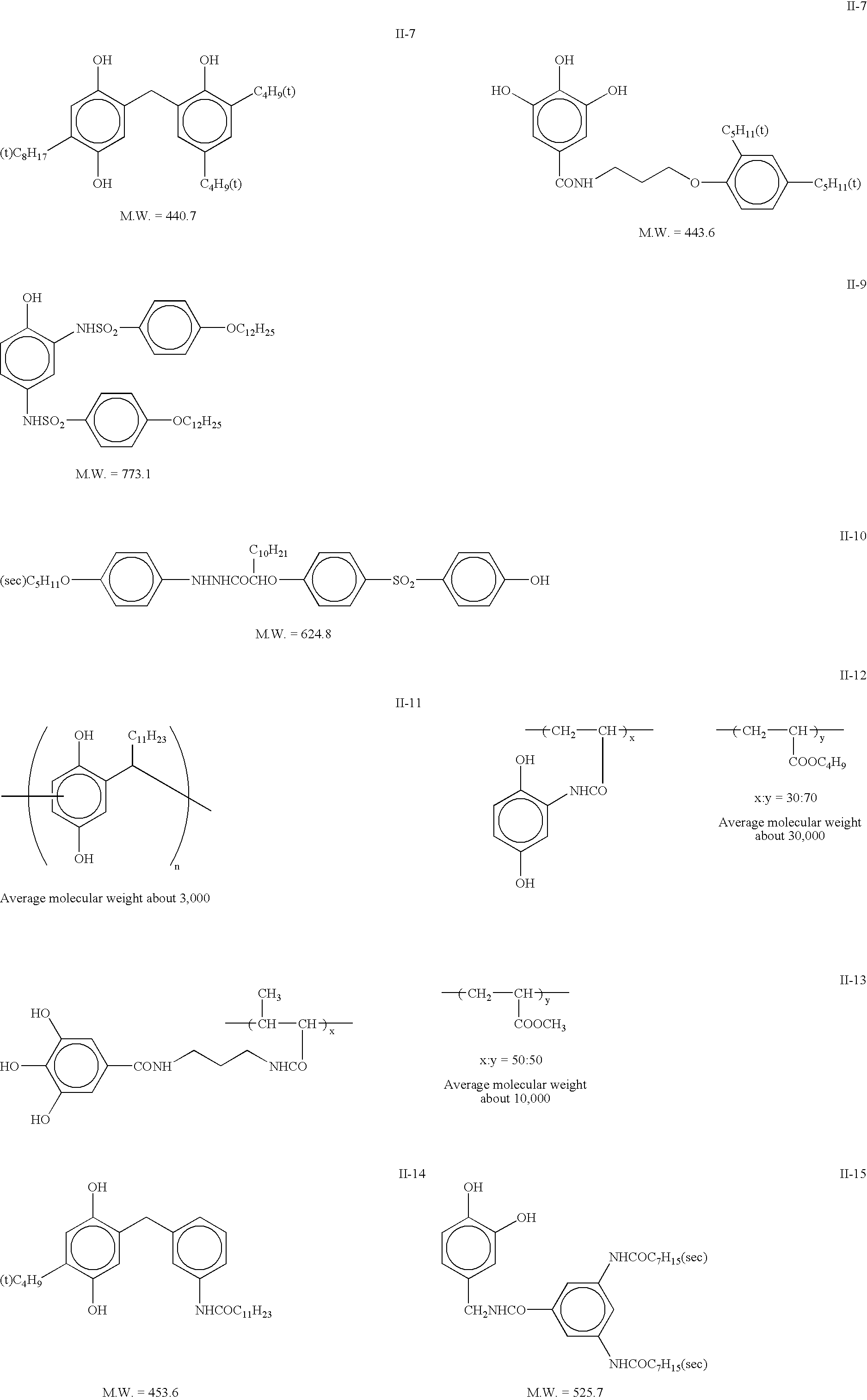

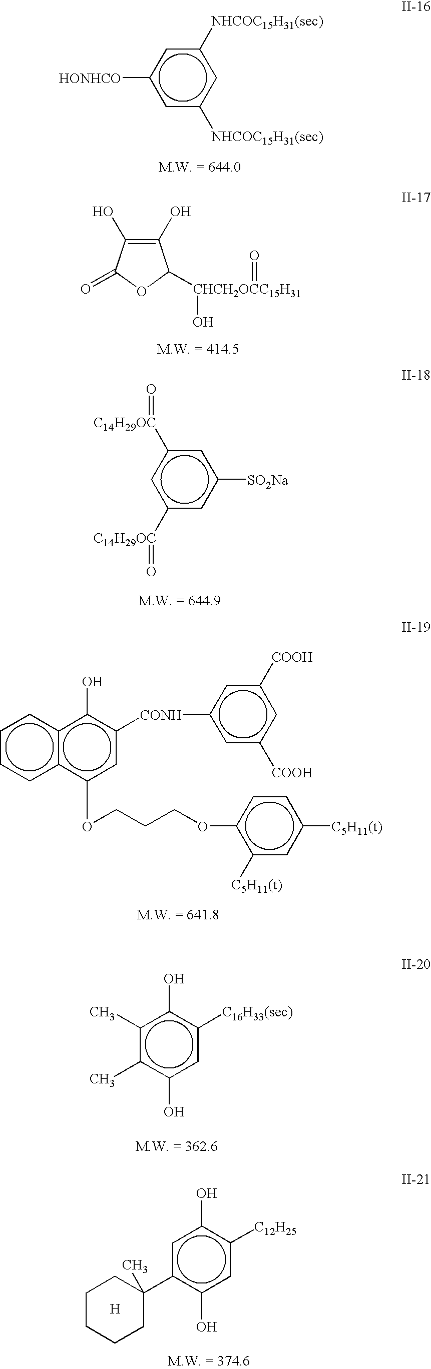

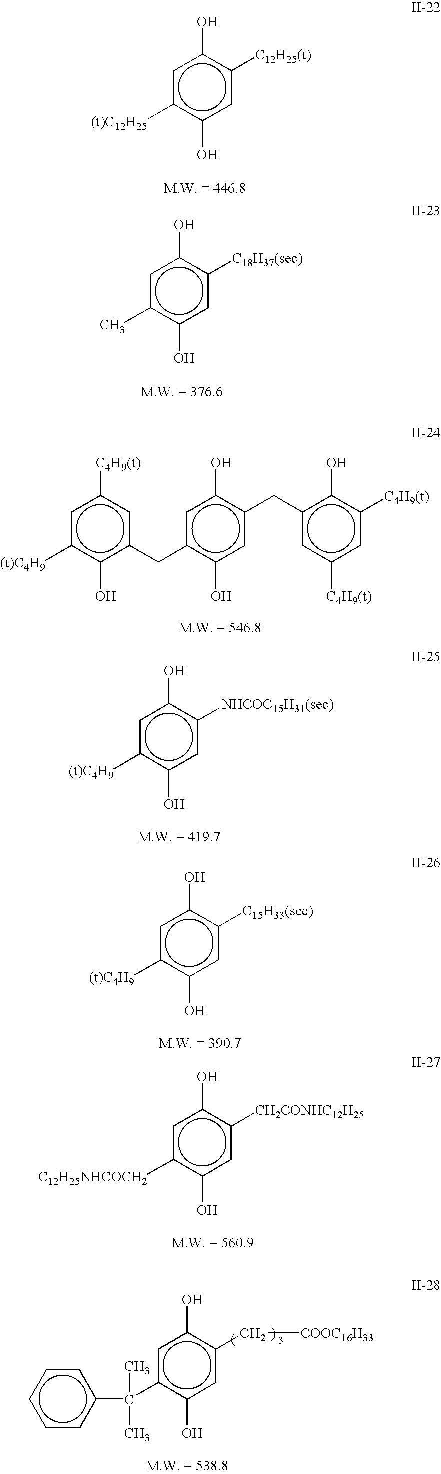

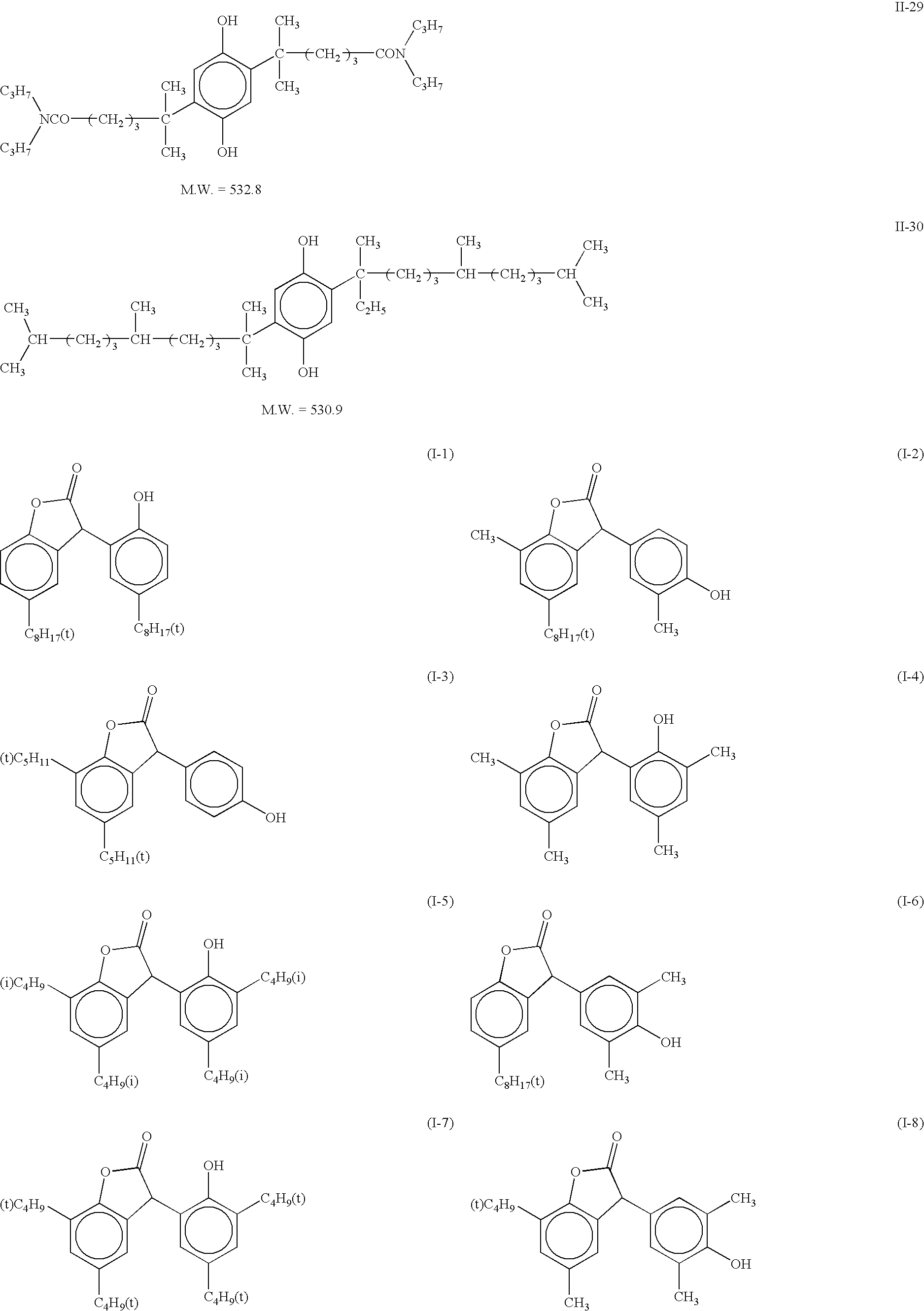

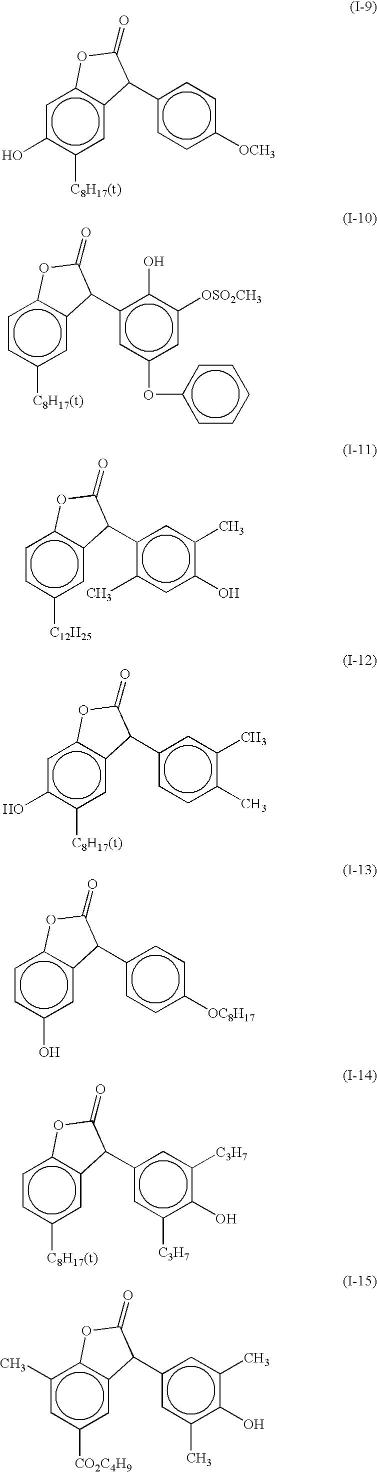

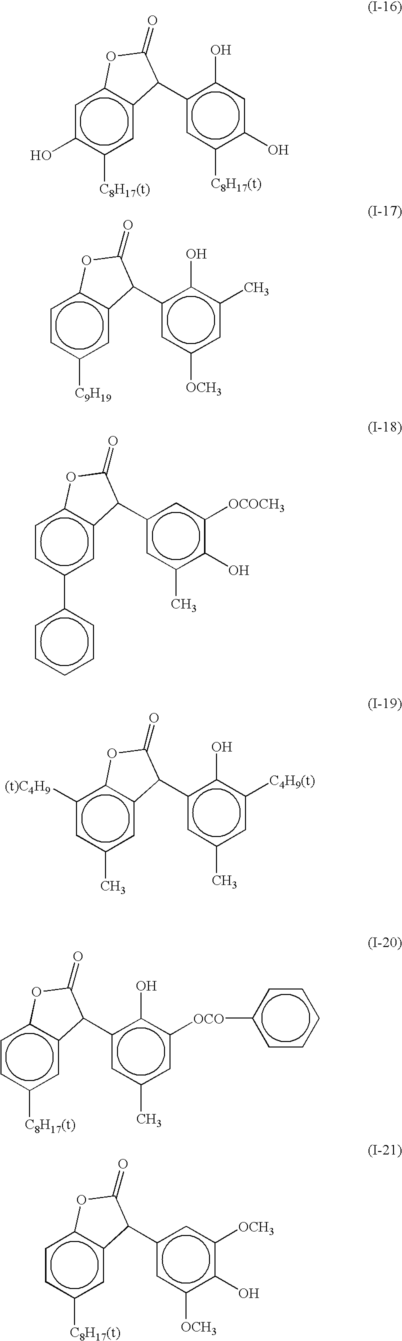

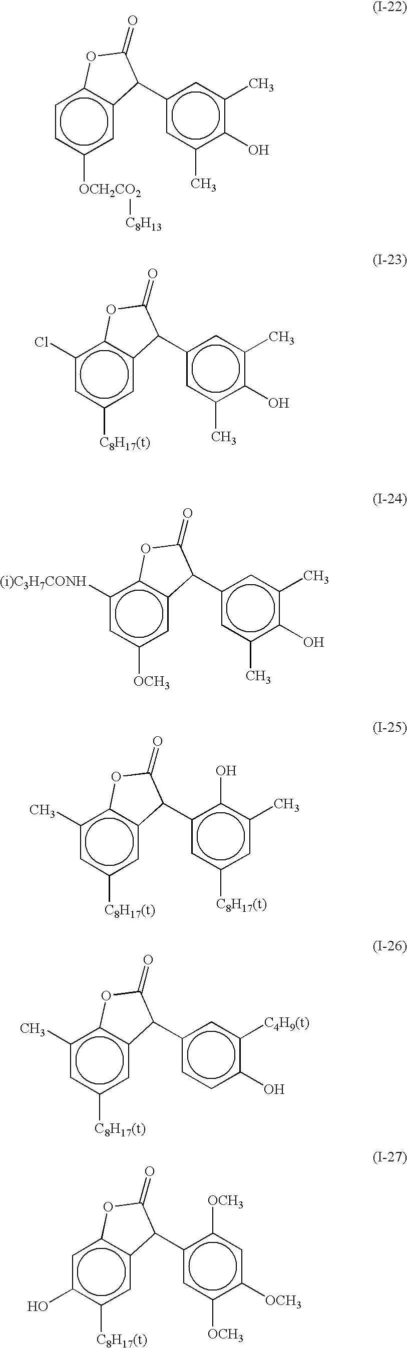

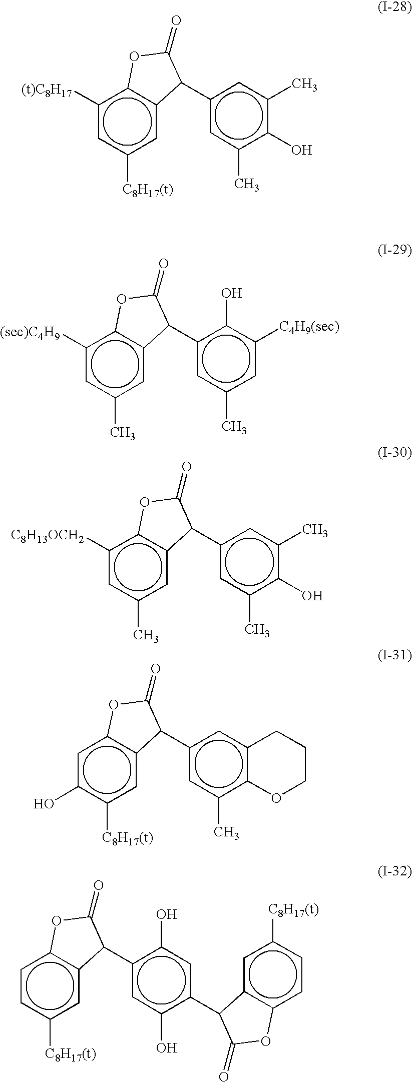

It is preferable that the nondiffusing reducing agent for use in the present invention is dissolved in a high-boiling organic solvent and incorporated into the color-mixing prevention layer in a state of fine oil droplets formed by emulsified dispersion. As the high-boiling organic solvent that can be used in the present invention, a high-boiling organic solvent having permittivity of 5.0 or above is preferable. Further preferable one is a high-boiling organic solvent having permittivity of 6.0 or above. The high-boiling organic solvent used may be a mixture of two or more thereof. In this case, the permittivity of the mixture is preferably 5.0 or above, more preferably 6.0 or above. Examples of a preferred high-boiling organic solvent include organic acid amides, ketones, and esters having permittivity of 6.0 or above, such as a phthalic acid ester and a phosphoric ester. The permittivity described above is a value measured by using a transformer bridge method (TRS-IOT (trade name), manufactured by Ando Electric Co., Ltd.) under a condition of 25° C.-10 kHz. It is preferable that the high-boiling organic solvent used has a boiling point of 140° C. or above and a melting point of 100° C. or below, and it is far preferable that the boiling-point is 160° C. or above and the melting point is 70° C. or below. The high-boiling organic solvent may be in a solid state at room temperature. In this case, the permittivity is a value measured under a condition that the high-boiling solvent changes its state into liquid (a supercooled condition). The ratio (by weight) of the amount of the high-boiling organic solvent used to the amount of the nondiffusing reducing agent used in the color-mixing prevention layer is preferably from 0.3 to 20, far preferably from 0.5 to 10, and further preferably from 1 to 8. The high-boiling organic solvent is preferably a compound represented by any one of formulae (III) to (VII).

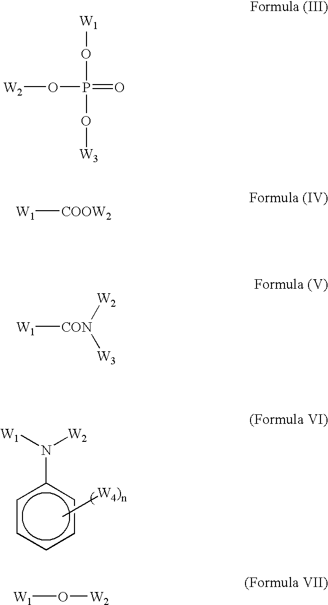

In formulae (III) to (VII), W₁, W₂ and W₃ each represent a substituted or unsubstituted alkyl, cycloalkyl, alkenyl, aryl or heterocyclic group; W₄ represents W₁, OW₁, or SW₁; and n represents an integer of from 1 to 5. When n is 2 or above, W₄s may be the same or different. W₁ and W₂, W₂ and W₃, or W₃ and W₁ may combine with each other to form a fused ring. Of the compounds represented by formulae (III) to (VII), the compounds represented by formulae (III), (IV) and (V) are preferred over the others. Specific examples of the high-boiling organic solvent that can be used in the present invention include those recited in JP-A-3-149545 and the exemplified compounds shown below (showing their structural formulae and permittivity values), but the present invention is not limited to those.

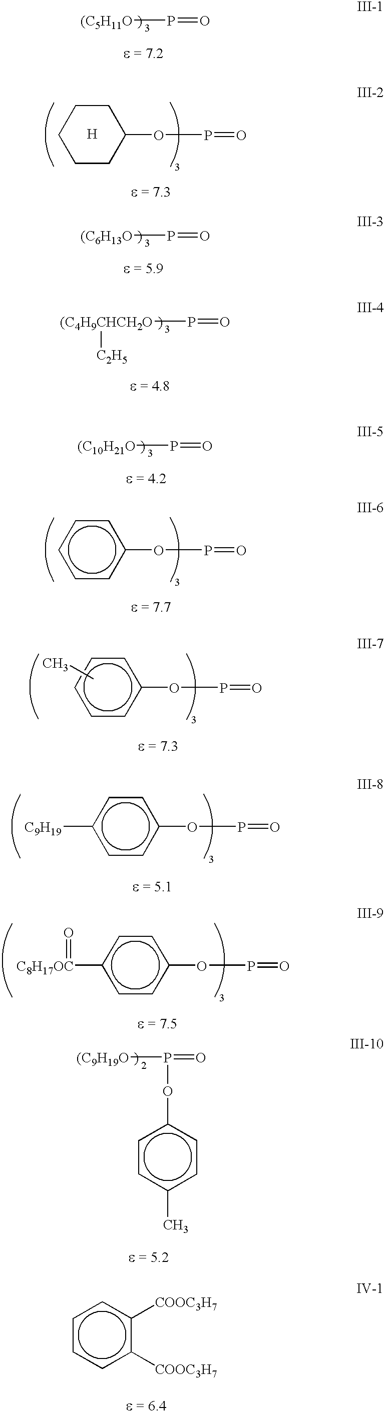

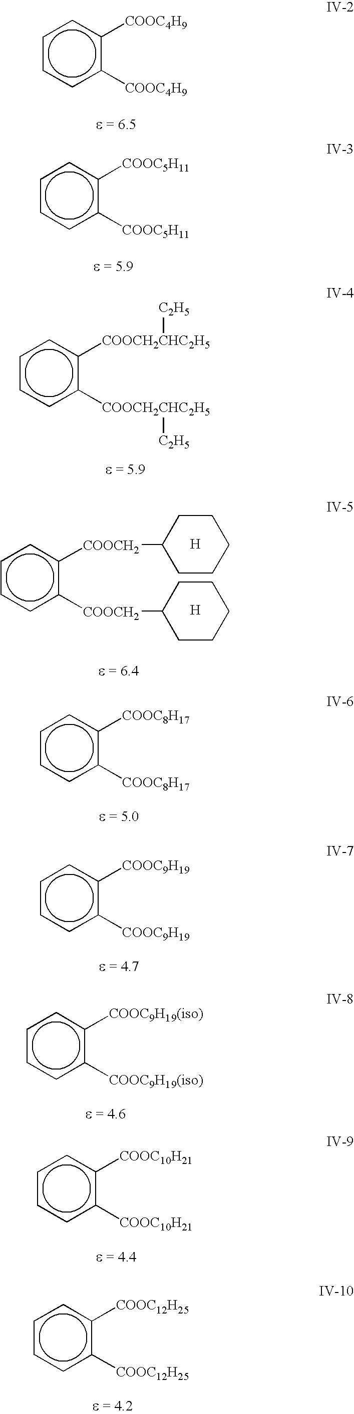

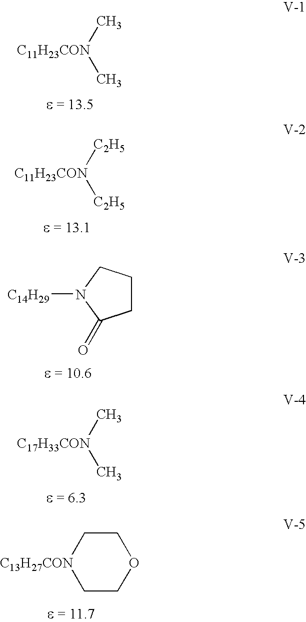

The light-sensitive layer has no particular restriction as to its thickness so far as it can achieve sufficient color reproduction and its total thickness does not render the light-sensitive sheet too thick.

(j) Others

The light-sensitive sheet can contain an irradiation preventive layer, a UV-absorbing layer, a protective layer and the like, according to the need.

The light-sensitive sheet also has no particular restriction as to its thickness so far as its thickness does not render the color diffusion transfer film unit too thick.

[3] Transparent Cover Sheet

(j) Second Transparent Support

The support of the transparent cover sheet may be any one of smooth transparent supports, as far as they are usually used for photographic light-sensitive materials. Examples of a preferred support include cellulose acetate, polystyrene, polyethylene terephthalate, polycarbonate, and the like. The support preferably contains a minute amount of a dye, to prevent light-piping. The support is preferably provided with an undercoat layer.

(k) Layer Having Neutralizing Function

The layer having neutralizing function (neutralizing layer) is a layer generally containing an acidic substance in an amount enough to neutralize an alkali delivered from the alkaline processing composition-containing material, and it may be one having a multilayer constitution comprising a neutralizing rate-controlling layer (neutralizing timing layer), an adhesion-reinforcing layer, and the like, according to the need.

A preferable acidic substance is a substance that contains an acidic group having a pKa of 9 or less (or a precursor group providing an acidic group having a pKa of 9 or less by hydrolysis). More preferable examples of the acidic substance include higher fatty acids, such as oleic acid, as described in U.S. Pat. No. 2,983,606; and polymers of acrylic acid, methacrylic acid, or maleic acid, and its partial esters or acid anhydrides, as disclosed in U.S. Pat. No. 3,362,819; copolymers of an acrylic acid and an acrylate, as disclosed in French Patent No. 2,290,699; and latex-type acidic polymers, as disclosed in U.S. Pat. No. 4,139,383 or RD No. 16102 (1977). Besides the above compounds, acidic substances as disclosed in U.S. Pat. No. 4,088,493, JP-A-52-153739, JP-A-53-1023, JP-A-53-4540, JP-A-53-4541, JP-A-53-4542, and the like are preferable.

Other examples of the acidic polymer (polymer acid) include a copolymer of a vinyl monomer, such as, ethylene, vinyl acetate and vinyl methyl ether, with maleic acid anhydride, and its n-butylester, copolymer of butylacrylate and acrylic acid, cellulose, and acetate/hydrodiene phthalate.

The aforementioned acidic polymer may be used by mixing with a hydrophilic polymer. Examples of such a hydrophilic polymer include polyacrylamide, polymethylpyrrolidone, polyvinyl alcohol (including partially saponified products), carboxymethyl cellulose, hydroxymethyl cellulose, hydroxyethyl cellulose, and polymethyl vinyl ether. Among these compounds, polyvinyl alcohol is preferable. Also, a polymer, such as cellulose acetate, other than the hydrophilic polymers, may be mixed with the above acidic polymer.

The amount of the acidic polymer to be applied is determined corresponding to the amount of an alkali in the alkaline processing composition-containing material. The equivalent ratio of the acidic polymer to the alkali per unit area is preferably 0.9 to 2.0. When the amount of the acidic polymer is too small, the hue of a transferred dye is changed, and stains occur on a white background portion; whereas when the amount is too large, this brings about disadvantages such as a change in the hue and reduced light resistance. A more preferable equivalent ratio is 1.0 to 1.3. The quality of photographs is also lowered if the amount of the hydrophilic polymer to be mixed is too large or too small. The mass ratio of the hydrophilic polymer to the acidic polymer is generally 0.01 to 10, and preferably 0.1 to 3.0.

Additives may be incorporated in the neutralizing layer, for various purposes. For example, a general hardener may be added for the purpose of film-hardening of the neutralizing layer, and a polyvalent hydroxyl compound, such as polyethylene glycol, polypropylene glycol, or glycerin (glycerol), may be added for the purpose of improving brittleness of the film. In addition, an antioxidant, a fluorescent whitening agent, a development inhibitor or its precursor, and the like may be added, if necessary.

As a material for the neutralizing timing layer that can be used in combination with the neutralizing layer, useful examples are a polymer that reduces alkali-permeability, such as gelatin, polyvinyl alcohol, partially acetalized polyvinyl alcohol, cellulose acetate, or partially hydrolyzed polyvinyl acetate; a latex polymer, which is produced by the copolymerization with a small amount of a hydrophilic comonomer such as an acrylic acid monomer, and which raises an active energy for the permeation of an alkali; and a polymer having a lactone ring.

Among these polymers, cellulose acetates used for forming the neutralizing timing layer, as disclosed in JP-A-54-136328, and U.S. Pat. No. 4,267,262, U.S. Pat. No. 4,009,030, U.S. Pat. No. 4,029,849, and the like; latex polymers, which are produced by the copolymerization of a small amount of a hydrophilic comonomer such as an acrylic acid, as disclosed in JP-A-54-128335, JP-A-56-69629, JP-A-57-6843 and U.S. Pat. No. 4,056,394, U.S. Pat. No. 4,061,496, U.S. Pat. No. 4,199,362, U.S. Pat. No. 4,250,243, U.S. Pat. No. 4,256,827, U.S. Pat. No. 4,268,604, and the like; polymers having a monoacrylate or monomethacrylate of a polyvalent alcohol, as disclosed in JP-A-11-2890; polymers having a lactone ring, as disclosed in U.S. Pat. No. 4,229,516; and other polymers as disclosed in JP-A-56-25735, JP-A-56-97346, JP-A-57-6842, European Patent (EP) No. 31,957A1, EP No. 37,724A1 and EP No. 48,412A1, and the like, are particularly useful.

In addition to the above, those described in the following literatures may also be used:

U.S. Pat. No. 3,421,893, U.S. Pat. No. 3,455,686, U.S. Pat. No. 3,575,701, U.S. Pat. No. 3,778,265, U.S. Pat. No. 3,785,815, U.S. Pat. No. 3,847,615, U.S. Pat. No. 4,088,493, U.S. Pat. No. 4,123,275, U.S. Pat. No. 4,148,653, U.S. Pat. No. 4,201,587, U.S. Pat. No. 4,288,523, U.S. Pat. No. 4,297,431, West Germany Patent Application (OLS) No. 1,622,936, ibid. 2,162,277, and RD 15162, No. 151 (1976).

To the neutralizing timing layer may be incorporated, a development inhibitor and/or its precursor, as disclosed in, for example, U.S. Pat. No. 4,009,029, West Germany Patent Application (OLS) No. 2,913,164, ibid. No. 3,014,672, JP-A-54-155837, and JP-A-55-138745; a hydroquinone precursor as disclosed in U.S. Pat. No. 4,201,578, and other useful photographic additives or their precursors. Moreover, as the neutralizing timing layer, to provide an auxiliary neutralizing layer as described in JP-A-63-168648 and JP-A-63-168649 has an effect in view of reducing a change of transferred density due to the lapse of time after processing.

The neutralizing timing layer may contain two or more of those materials. A plurality of materials may be contained in one layer or in a plurality of layers, respectively.

(l) Other Layers

Other than the layer having a neutralizing function, the transparent cover sheet may contain a backing layer, protective layer, filter dye layer, and the like, as layers having auxiliary functions.

The backing layer is provided to control curling, and to impart lubricity. The backing layer may contain the filter dye. The protective layer is used primarily to prevent adhesion to the backface of the cover sheet, specifically to prevent the adhesion of the cover sheet to the protective layer of the light-sensitive material when the light-sensitive material and the cover sheet are overlaid (superimposed) on each other. When the transparent cover sheet contains a dye, it becomes possible to control the sensitivity of the light-sensitive layer. The filter dye may be added directly to the inside of a support of the cover sheet, or to the layer having a neutralizing function, and further, to the aforementioned backing layer, protective layer, capture mordant layer or the like. Alternatively, a single layer containing the filter dye may be formed.

[4] Others

Any one of the light-sensitive sheet, the transparent cover sheet, and the alkaline processing composition-containing material may contain a development accelerator described on pp. 72-91, a hardener described on pp. 146-155, a surfactant described on pp. 201-210, a fluorine-containing compound described on pp. 210-222, a viscosity-enhancing agent on pp. 225-227, an antistatic agent described on pp. 227-230, a polymer latex described on pp. 230-239, a matte agent described on page 240, and the like, each of which is described in JP-A-62-215272. Also, it may contain a tertiary amine latex as described in JP-A-6-273907, JP-A-7-134386, JP-A-7-175193, or JP-A-7-287372.

The exposure method that can be applied to the diffusion transfer film unit of the present invention is preferably an exposure method using an exposure head equipped with a plurality of light sources each emitting light in a specified wavelength region. For instance, the exposure can be performed according to the method as described in JP-A-11-344772.

Preferred examples of the exposure head having a plurality of light sources each emitting light in a specified wavelength region include an LED head, an organic EL head, an inorganic EL head and a field-emission head. Of these heads, an organic EL head is preferred over the others.

In addition, the color diffusion transfer film unit of the present invention can be exposed to light in light quantity modulated based on image formation, according to the method described in, for example, JP-A-11-344772.

According to the present invention, it is possible to provide a silver halide color diffusion transfer film unit ensured with rapid image formation, reduced color-mixing and forming of deep blacks, and an image-formation method using the same to form the advantages.

According to the present invention, it is possible to provide a color diffusion transfer light-sensitive material and a color diffusion transfer film unit that provide a satisfactorily pure whiteness and a sufficient density despite of reduction of coating silver amount. In addition, according to the image-formation method of the present invention, it is possible to form an image having excellent deep blacks with reduced color-mixing quickly.

The present invention will be explained in more detail by way of the following examples, but the invention is not intended to be limited thereto.

### EXAMPLES

### Example 1

1. Preparation of Light-Sensitive Sheet

First, a light-sensitive element (Light-sensitive sheet 201) having the layer constitution as shown below was prepared.

Constitution of light-sensitive sheet 201

| Number of layer | Name of layer | Additive | Coated amount (g/m²) |
|---|---|---|---|
| 16th layer | Protective layer | Matting agent (1) | 0.35 |
| | | Gelatin | 0.2 |
| | | Surfactant (1) | 4.0 × 10⁻³ |
| | | Surfactant (11) | 1.4 × 10⁻³ |
| | | Surfactant (3) | 9.0 × 10⁻³ |
| | | Additive (1) | 8.0 × 10⁻³ |
| | | Additive (24) | 1.9 × 10⁻⁵ |
| | | Additive (25) | 0.003 |
| | | Hardener (3) | 0.017 |
| 15th layer | Ultraviolet-absorbing | Ultraviolet absorber (1) | 0.09 |
| | layer | Ultraviolet absorber (6) | 0.05 |
| | | Ultraviolet absorber (3) | 0.01 |
| | | Surfactant (1) | 0.01 |
| | | Surfactant (3) | 0.013 |
| | | Surfactant (5) | 0.006 |
| | | Additive (1) | 8.0 × 10⁻³ |
| | | Additive (5) | 0.008 |
| | | Additive (26) | 0.024 |
| | | Additive (27) | 0.008 |
| | | Additive (24) | 7.5 × 10⁻⁵ |
| | | Additive (25) | 0.007 |
| | | Hardener (1) | 0.11 |
| | | Hardener (2) | 0.04 |
| | | Gelatin | 0.46 |
| | | High-boiling organic solvent (1) | 0.015 |
| | | High-boiling organic solvent (3) | 0.018 |
| 14th layer | Blue-sensitive layer | Surface-latent-image-type Emulsion: J | 0.19 |
| | | | (in terms of silver) |
| | | Additive (1) | 9.0 × 10⁻³ |
| | | Additive (24) | 4.4 × 10⁻⁵ |
| | | Additive (25) | 0.018 |
| | | Surfactant (1) | 1.0 × 10⁻³ |
| | | Gelatin | 0.22 |
| 13th layer | Yellow color material | Yellow dye-releasing compound (1) | 0.38 |
| | layer | High-boiling organic solvent (1) | 0.24 |
| | | Additive (5) | 0.024 |
| | | Additive (6) | 0.11 |
| | | Additive (7) | 0.06 |
| | | Additive (24) | 2.9 × 10⁻³ |
| | | Surfactant (4) | 0.038 |
| | | Surfactant (5) | 0.018 |
| | | Additive (9) | 0.019 |
| | | Additive (1) | 4.7 × 10⁻³ |
| | | Gelatin | 0.53 |
| 12th layer | Yellow filter layer | Yellow colloidal silver | 0.03 |
| | | | (in terms of silver) |
| | | Surfactant (1) | 1.0 × 10⁻³ |
| | | Additive (1) | 7.0 × 10⁻³ |
| | | Additive (28) | 3.6 × 10⁻³ |
| | | Additive (24) | 2.3 × 10⁻⁵ |
| | | Additive (25) | 0.003 |
| | | Gelatin | 0.23 |
| 11th layer | Color-mixing | Additive (26) | 0.26 |
| | prevention layer | Additive (27) | 0.09 |
| | | Additive (24) | 3.4 × 10⁻⁵ |
| | | Additive (25) | 0.012 |
| | | High-boiling organic solvent (1) | 0.16 |
| | | Surfactant (5) | 0.06 |
| | | Gelatin | 0.53 |
| 10th layer | Green-sensitive layer | Surface-latent-image-type Emulsion: K | 0.33 |
| | | | (in terms of silver) |
| | | Additive (1) | 0.01 |
| | | Additive (31) | 4.7 × 10⁻⁴ |
| | | Additive (24) | 4.3 × 10⁻⁵ |
| | | Additive (25) | 0.006 |
| | | Surfactant (1) | 1.0 × 10⁻³ |
| | | Gelatin | 0.22 |
| 9th layer | Magenta color | Magenta dye-releasing compound (2) | 0.35 |
| | material layer | High-boiling organic solvent (1) | 0.09 |
| | | Additive (1) | 5.0 × 10⁻³ |
| | | Additive (3) | 9.3 × 10⁻³ |
| | | Additive (5) | 0.01 |
| | | Additive (6) | 0.06 |
| | | Additive (7) | 0.03 |
| | | Additive (9) | 0.05 |
| | | Additive (14) | 0.02 |
| | | Additive (24) | 1.6 × 10⁻³ |
| | | Additive (25) | 0.004 |
| | | Surfactant (4) | 0.04 |
| | | Surfactant (5) | 0.01 |
| | | Gelatin | 0.43 |
| 8th layer | Intermediate layer | Additive (29) | 2.0 × 10⁻⁴ |
| | | Surfactant (1) | 1.0 × 10⁻³ |
| | | Additive (1) | 6.0 × 10⁻³ |
| | | Additive (30) | 6.3 × 10⁻⁵ |
| | | Additive (24) | 3.9 × 10⁻⁵ |
| | | Additive (25) | 0.006 |
| | | Gelatin | 0.2 |
| 7th layer | Color-mixing | Additive (26) | 0.26 |
| | prevention layer | Additive (27) | 0.09 |
| | | Additive (24) | 3.5 × 10⁻⁵ |
| | | Additive (25) | 0.012 |
| | | High-boiling organic solvent (1) | 0.16 |
| | | Surfactant (5) | 0.06 |
| | | Gelatin | 0.53 |
| 6th layer | Red-sensitive layer | Surface-latent-image-type Emulsion: L | 0.25 |
| | | | (in terms of silver) |
| | | Additive (1) | 8 × 10⁻³ |
| | | Additive (24) | 2.5 × 10⁻⁵ |
| | | Additive (25) | 0.004 |
| | | Gelatin | 0.13 |
| 5th layer | Cyan color material | Cyan dye-releasing compound (2) | 0.24 |
| | layer | High-boiling organic solvent (1) | 0.07 |
| | | Additive (5) | 5.0 × 10⁻³ |
| | | Additive (6) | 0.02 |
| | | Additive (7) | 0.01 |
| | | Surfactant (1) | 0.002 |
| | | Surfactant (4) | 0.02 |
| | | Surfactant (5) | 0.004 |
| | | Additive (9) | 0.024 |
| | | Additive (1) | 4.0 × 10⁻³ |
| | | Additive (24) | 7.6 × 10⁻⁴ |
| | | Additive (25) | 0.005 |
| | | Hardener (3) | 0.007 |
| | | Gelatin | 0.24 |
| 4th layer | Light-shielding layer | Carbon black | 1.56 |
| | | Surfactant (1) | 0.082 |
| | | Surfactant (5) | 0.014 |
| | | Additive (1) | 4.48 × 10⁻⁵ |
| | | Additive (3) | 0.033 |
| | | Additive (5) | 0.098 |
| | | Additive (14) | 0.094 |
| | | Additive (24) | 4.4 × 10⁻⁵ |
| | | Additive (25) | 0.037 |
| | | Gelatin | 1.17 |
| 3rd layer | Intermediate | Additive (1) | 4.53 × 10⁻⁵ |
| | layer | Additive (5) | 0.014 |
| | | Additive (24) | 5.7 × 10⁻⁵ |
| | | Additive (25) | 0.008 |
| | | Surfactant (1) | 0.001 |
| | | Gelatin | 0.29 |
| 2nd layer | White reflection layer | Titanium dioxide | 18 |
| | | Additive (8) | 0.144 |
| | | Additive (15) | 0.377 |
| | | Additive (16) | 0.026 |
| | | Additive (24) | 6.2 × 10⁻⁴ |
| | | Additive (25) | 0.027 |
| | | Surfactant (1) | 0.015 |
| | | Surfactant (6) | 0.014 |
| | | Gelatin | 2.81 |
| 1st layer | Image-receiving layer | Polymer mordant (1) | 2.817 |
| | | Additive (17) | 0.226 |
| | | Surfactant (12) | 0.04 |
| | | Additive (5) | 0.1 |
| | | Gelatin | 3.19 |

Support (97 μm of polyethylene terephthalate containing titanium dioxide for preventing
light piping, and provided with an undercoat)

| | | | |
|---|---|---|---|
| Backing layer | Curl-controlling layer | Latex (1) | 0.025 |
| | | Latex (2) | 0.025 |

The compounds used for the preparation of the light-sensitive sheet (light-sensitive sheet 201) are shown below.

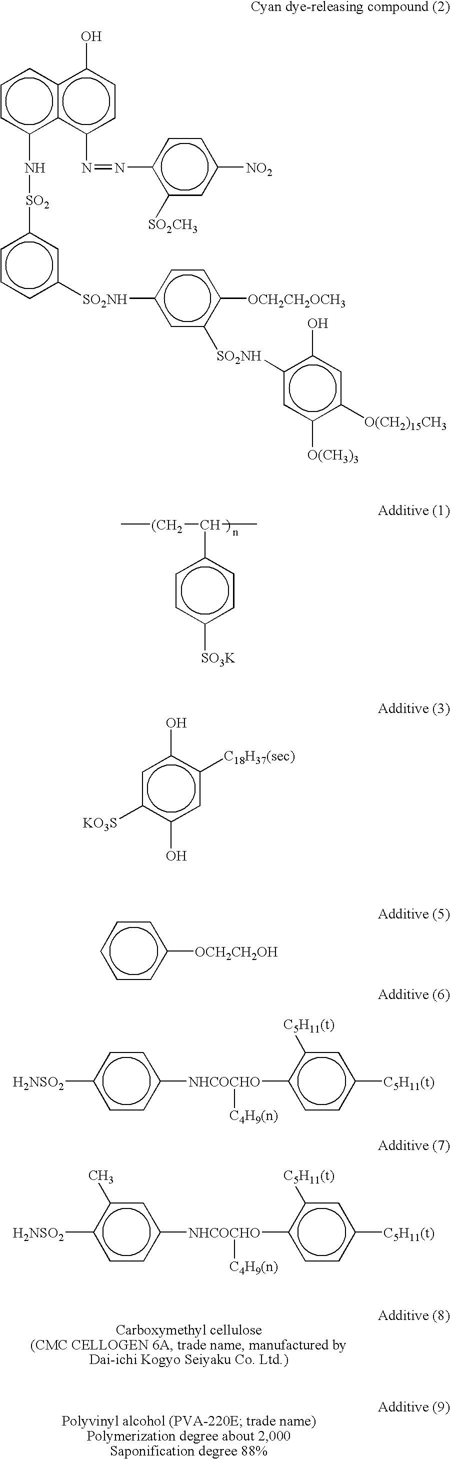

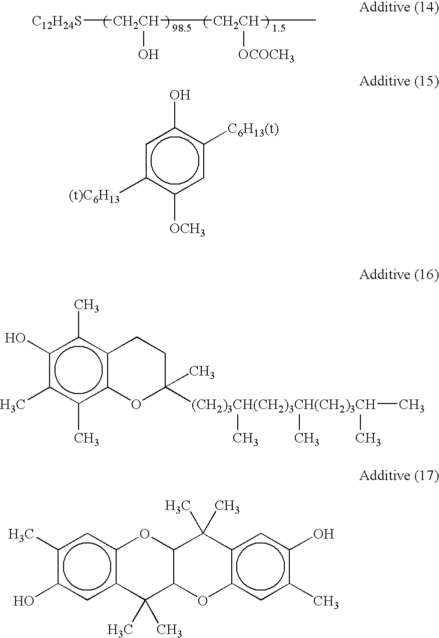

Matt Agent

Latex of sphere polymethyl methacrylate (average particle diameter: 3 μm)

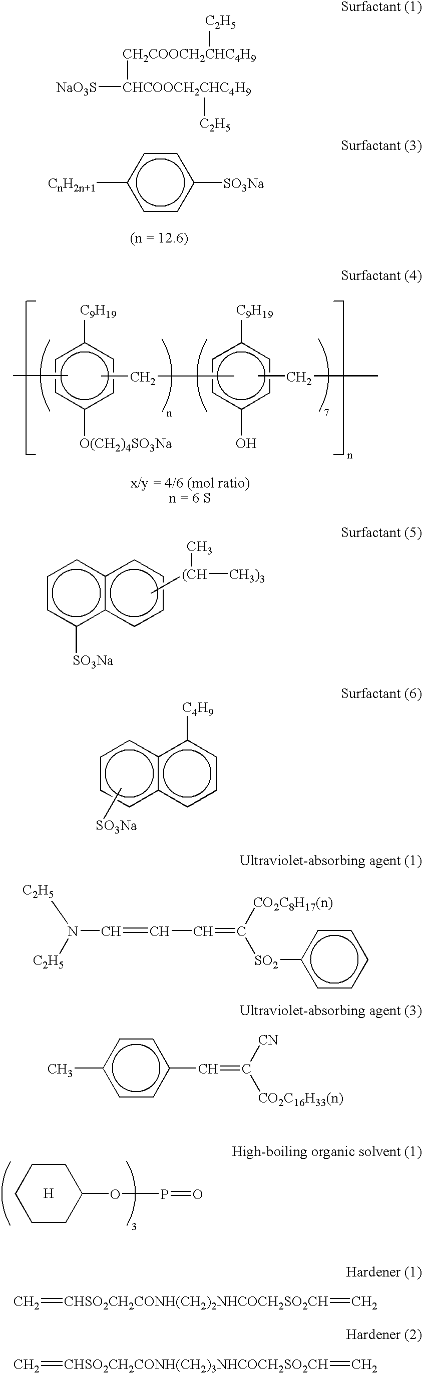

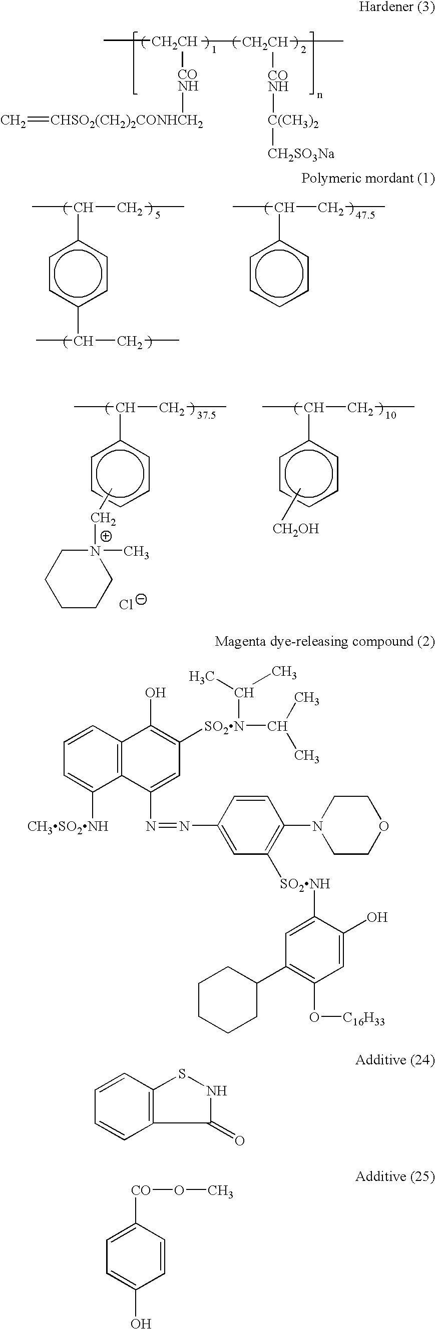

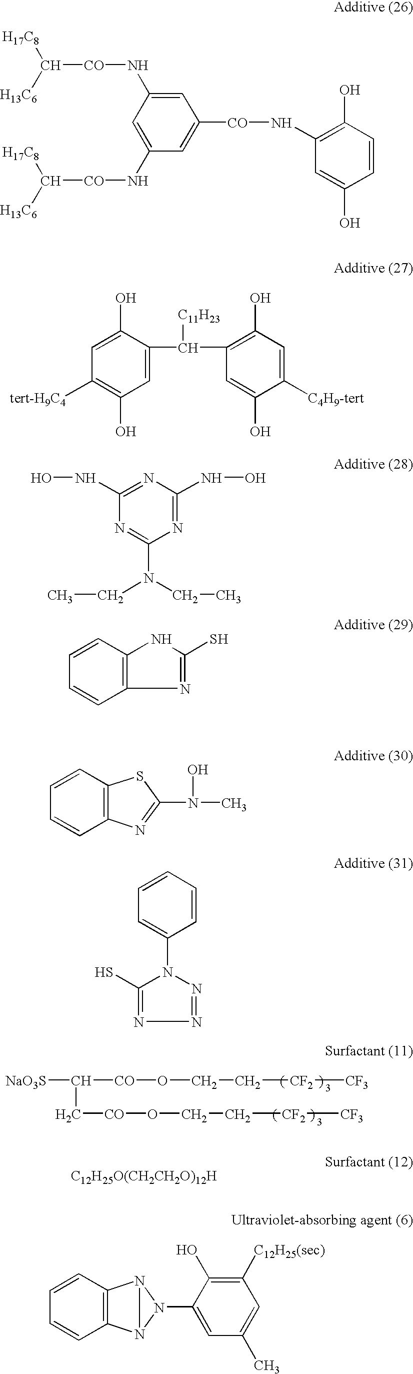

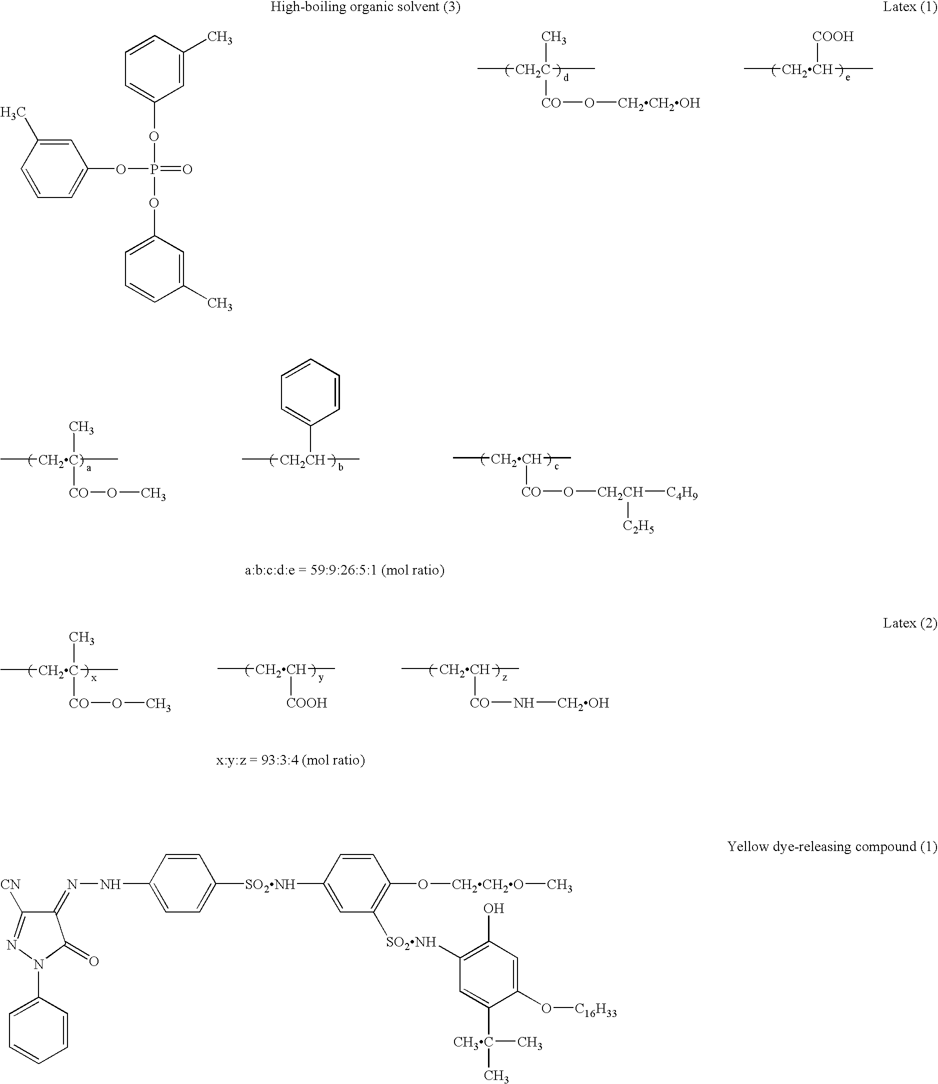

Of the foregoing compounds, the additives (26) and (27) contained in the color-mixing prevention layers fall under the category of the nondiffusing reducing agent preferably used in the present invention.

Three types of the negative silver halide emulsions J, K and L were prepared in accordance with the method described below. In preparing the emulsions J, K and L, gelatin having a mass average molecular weight of 2×10⁴ or below was used as the low-molecular-weight gelatin described below, and gelatin with a Ca content of 100 ppm or below was used as the deionized gelatin described below.

Preparation of Green-Sensitive Emulsion K

The emulsion K was prepared as follows:

To 0.7 L of an aqueous gelatin solution containing 0.005 mol of potassium bromide and 1.1 g of low-molecular-weight gelatin, were added 26.5 mL of an aqueous solution of silver nitrate at a concentration of 0.58 mol/L and 46.4 ml of an aqueous solution containing potassium bromide at a concentration of 0.42 mol/L and 1.5 mass % of low-molecular-weight gelatin, at the same time, with vigorous stirring, over a period of 1 minute by a double-jet method. During the addition, the aqueous gelatin solution was kept at 35° C. After 0.5 g of potassium bromide was added, the temperature of the solution was raised to 75° C. at a gradient of 1.5° C./minute.

After the temperature reached 75° C., 5 ml of 4.9% sulfuric acid aqueous solution and 0.16 L of an aqueous gelatin solution containing 16 mass % of deionized gelatin were added. Subsequently, an aqueous solution of silver nitrate at a concentration of 1.88 mol/L and an aqueous solution of potassium bromide at a concentration of 1.88 mol/L were added, at an accelerated flow rate of the gelatin solution containing sulfuric acid (the final flow rate was 3.5 times the initial flow rate) over a period of 44 minutes by a double-jet method. The amount of the aqueous solution of silver nitrate added was 366 mL, and the amount of the aqueous solution of potassium bromide added was 375 mL.

Next, 0.08 L of an aqueous gelatin solution containing 14 mass % of deionized gelatin having a Ca content of 100 ppm or less, and 2 mg of sodium benzenethiosulfate was added. After that, an aqueous solution of silver nitrate at a concentration of 1.88 mol/L and an aqueous solution of potassium bromide at a concentration of 1.88 mol/L were added, at an accelerated flow rate of the gelatin solution containing sodium benzenethiosulfate (the final flow rate was 1.2 times the initial flow rate), over a period of 11 minutes, by a double-jet method. The amount of the aqueous solution of silver nitrate added was 157 ml, and the amount of the aqueous solution of potassium bromide added was 163 mL.

Next, after 4.6 g of potassium bromide was added, the resulting emulsion was washed with water according to a usual flocculation method. After that, deionized gelatin, 2-phenoxyethanol, and methyl p-hydroxybenzoate were added. After the addition, pH was adjusted to 5.8 and pAg was adjusted to 8.8 in order that 1.35 mol of silver and 84 g of gelatin were contained per kg of the emulsion. 0.74 kg of the mixture containing silver nitrate and potassium bromide prepared in this manner was heated to 55° C. Then, 0.5 g of potassium iodide, 4.2×10⁻⁴ mol of the sensitizing dye (6) and 5.4×10⁻⁴ mol of the sensitizing dye (7) were added to the mixture, which was then ripened for 30 minutes. Next, 5.0×10⁻⁴ mol of potassium thiocyanate, 1.4×10⁻⁵ mol of potassium tetrachloroaurate and 1.2×10⁻⁵ mol of sodium thiosulfate were added to the mixture, which was then ripened for 60 minutes. The compound (E-4) was added in an amount of 1.0×10⁻³ mol during ripening, and the compound (E-5) was added in an amount of 3.2×10⁴ mol at the end of the ripening to the mixture, to complete the preparation of the emulsion.

As a result of the observation of the emulsion K by means of an electron microscope, the average of grain thicknesses hi (=Σhi×ni/Σni) was 0.118 μm and the average of circle-equivalent diameters Di of grains (=ΣDi×ni/Σni) was 1.27 μm. The diameter of a circle, whose area is equal to the projected area of an individual grain when seen in the main plane direction thereof, is referred to as the circle-equivalent diameter. The average aspect ratio defined by the average of circle equivalent diameters Di/the average of grain thicknesses hi was 11.0. The average sphere-equivalent diameter of the grains was 0.63 μm. The diameter of a sphere, whose volume is equal to the volume of an individual grain, is referred to as the sphere-equivalent diameter.

Preparation of Blue-Sensitive Emulsion J

In the method of preparing the emulsion K, 9.2×10⁻⁴ mol of the sensitizing dye (9) was added in place of the sensitizing dyes (6) and (7), to prepare an emulsion J.

Preparation of Red-Sensitive Emulsion L

In the method of preparing the emulsion K, 8.4×10⁻⁴ mol of the sensitizing dye (1), 2.6×10⁻⁵ mol of the sensitizing dye (2) and 1.7×10⁻⁴ mol of the sensitizing dye (3) were added in place of the sensitizing dyes (6) and (7), to prepare an emulsion L.

Preparation of Emulsions J2, J3, K2, K3, L2 and L3

Blue-sensitive emulsions J2 and J3 were prepared in the same manner as emulsion J, except that the temperature and pAg during the grain formation were changed so that these emulsions had different grain sizes and aspect ratios from those of the emulsion J. In preparing the emulsions J2 and J3, the addition amounts of the sensitizing dye, potassium thiocyanate, potassium tetrachloroaurate, sodium thiosulfate and the compound (E-4) were changed to optimal amounts, respectively.

Green-sensitive emulsions K2 and K3 were prepared in the same manner as emulsion K, except that the temperature and pAg during the grain formation were changed so that these emulsions had different grain sizes and aspect ratios from those of the emulsion K. In preparing the emulsions K2 and K3, the addition amounts of the sensitizing dyes, potassium thiocyanate, potassium tetrachloroaurate, sodium thiosulfate and the compound (E-4) were changed to optimal amounts, respectively.

Red-sensitive emulsions L2 and L3 were prepared in the same manner as emulsion L, except that the temperature and pAg during the grain formation were changed so that these emulsions had different grain sizes and aspect ratios from those of the emulsion L. In preparing the emulsions L2 and L3, the addition amounts of the sensitizing dyes, potassium thiocyanate, potassium tetrachloroaurate, sodium thiosulfate and the compound (E4) were changed to optimal amounts, respectively.

Observations with an electron microscope revealed that emulsions J2, K2 and L2 had almost the same grain sizes and grain-size distributions. Specifically, the average grain thickness, average circle-equivalent diameter, average sphere-equivalent diameter and average aspect ratio of each emulsion were 0.155 μm, 1.00 μm, 0.63 μm and 7.2, respectively. Further, observations with the electron microscope revealed that emulsions J3, K3 and L3 had almost the same grain sizes and grain-size distributions. Specifically the average circle-equivalent diameter, average grain thickness, average aspect ratio and average sphere-equivalent diameter of each emulsion were 1.47 μm, 0.135 μm, 10.0 and 0.91 μm, respectively.

The characteristics of each of the emulsions prepared are shown in Table 1.

TABLE 1

| | | Average sphere- | | Average |
|---|---|---|---|---|
| | | equivalent | | aspect |
| Emulsion | Sensitivity for colors | diameter (μm) | External shape of grains | ratio |
| J | Blue-sensitive emulsion | 0.63 | Hexagonal tabular grains | 11.0 |
| J2 | Blue-sensitive emulsion | 0.63 | Hexagonal tabular grains | 7.2 |
| J3 | Blue-sensitive emulsion | 0.91 | Hexagonal tabular grains | 10.0 |
| K | Green-sensitive emulsion | 0.63 | Hexagonal tabular grains | 11.0 |
| K2 | Green-sensitive emulsion | 0.63 | Hexagonal tabular grains | 7.2 |
| K3 | Green-sensitive emulsion | 0.91 | Hexagonal tabular grains | 10.0 |
| L | Red-sensitive emulsion | 0.63 | Hexagonal tabular grains | 11.0 |
| L2 | Red-sensitive emulsion | 0.63 | Hexagonal tabular grains | 7.2 |
| L3 | Red-sensitive emulsion | 0.91 | Hexagonal tabular grains | 10.0 |

The compounds used for the preparation of the emulsions are shown below.

| | |
|---|---|
| 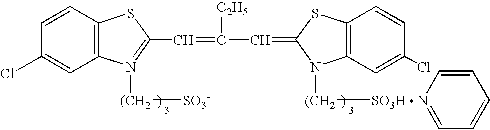 | Molecular weight: 728.77 Molecular formula: C₂₅H₂₆Cl₂N₂O₆S₄. C₅H₅N₁Sensitizing dye (1) |
| 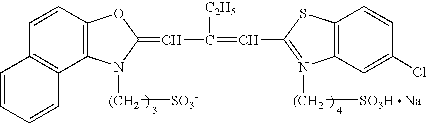 | Molecular weight: 686.24 Molecular formula: C₃₀H₃₁Cl₁N₂O₇S₃. NA₁Sensitizing dye (3) |
| 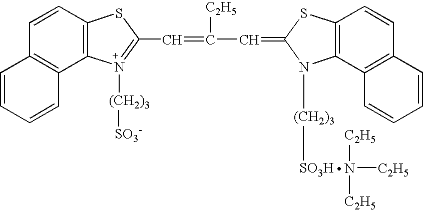 | Molecular weight: 782.09 Molecular formula: C₃₃H₃₂N₂O₆S₄. C₆H₁₄N₁Sensitizing dye (2) |
| 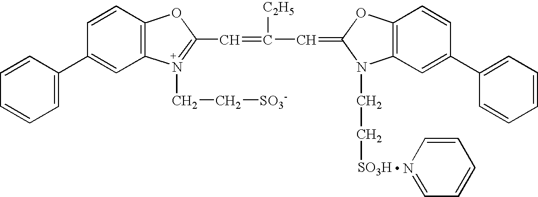 | Molecular weight: 751.89 Molecular formula: C₃₅H₃₂N₂O₂S₂. C₅H₅N₁Sensitizing dye (7) |
| 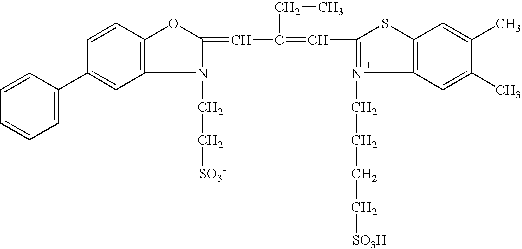 | Molecular weight: 707.96 Molecular formula: C₃₃H₃₆N₂O₇S₃.K₁Sensitizing dye (4) |
| 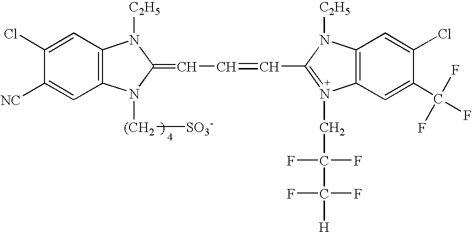 | Molecular weight: 742.57 Molecular formula: C₃₀H₂₅Cl₂F₇N₅O₃S₁Sensitizing dye (6) |
| 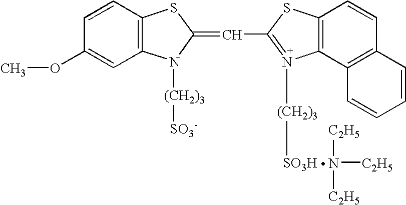 | Molecular weight: 707.96 Molecular formula: C₂₆H₂₆N₃O₇S₄. C₆H₅N₁Sensitizing dye (9) |
| 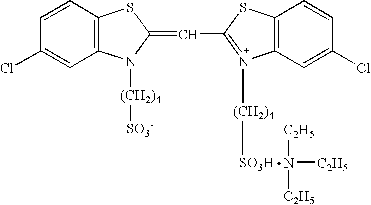 | Molecular weight: 724.83 Molecular formula: C₂₃H₂₄Cl₂N₂O₆S₄. C₆H₁₅N₁Sensitizing dye (5) |
| 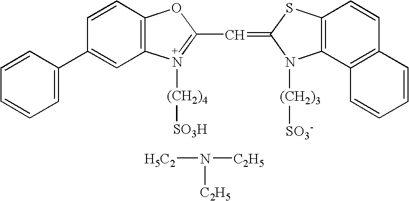 | Molecular weight: 752.00 Molecular formula: C₃₂H₃₀N₂O₇S₃. C₆H₁₄N₁Sensitizing dye (8) |

(E-4)

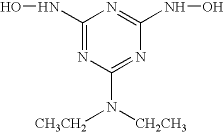

(E-5)

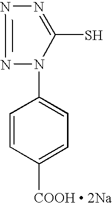

2. Preparation of Transparent Cover Sheet

Application was performed onto a polyethylene terephthalate transparent support having a thickness of 75 μm so as to provide each layer as shown below. Thus, a cover sheet 201 was formed.

Constitution of the cover sheet 201

| | | | Coated |
|---|---|---|---|
| Number of | | | amount |
| layer | Name of layer | Additive | (g/m²) |
| Third layer | Temperature- | Temperature-compensating | 0.43 |
| | compensating | polymer (1) | |
| | layer | Temperature-compensating | 1.12 |
| | | polymer (2) | |
| | | Surfactant (8) | 0.005 |
| | | Additive (21) | 0.17 |
| Second layer | Alkali barrier | Cellulose acetate | 2.80 |
| | layer | (Acetylation degree 51%) | |
| | | Additive (20) | 0.2 |
| | | Additive (21) | 0.17 |
| First layer | Neutralizing layer | Acid polymer (1) | 10.1 |
| | | Cellulose acetate | 0.7 |
| | | (Acetylation degree 45%) | |
| | | Hardener (5) | 0.05 |

Support (75 μm of polyethylene terephthalate provided with an undercoat)

| | | | |
|---|---|---|---|
| Backing layer | Curl-controlling | Additive (20) | 0.25 |
| | layer | Hardener (4) | 0.45 |
| | | Cellulose acetate | 4.14 |
| | | (Acetylation degree 55%) | |
| | | Silica (average particle | 0.02 |
| | | diameter: 3 to 4 μm) | |

The followings show chemical structures and the like of the compounds used in the transparent cover sheet. 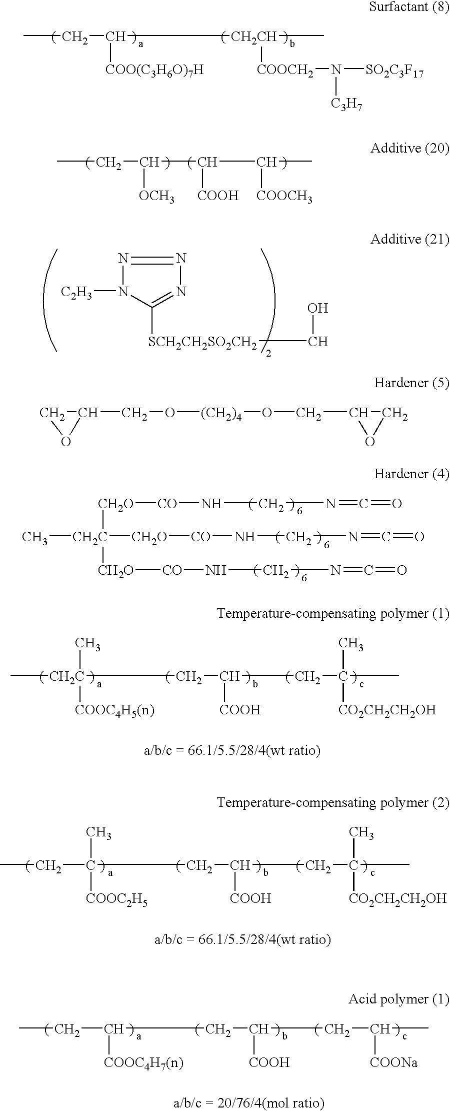
3. Preparation of Alkaline Processing Composition-Containing Material

An alkaline processing composition-containing material having the following composition described below (processing solution 201) was prepared.

| | | |
|---|---|---|
| Carbon black | 224.3 | g |
| Additive (23) | 12.1 | g |
| Viscosity-enhancing agent (sodium carboxymethyl | 43.0 | g |
| cellulose) | | |
| Potassium sulfite (anhydride) | 1.90 | g |
| 5-Methylbenzotriazole | 6.75 | g |
| 1-Phenyl-4-hydroxymethyl-4-methyl-3-pyrazolidone | 13.6 | g |
| Potassium hydroxide | 52.7 | g |
| Zinc nitrate | 0.60 | g |
| Benzyl alcohol | 2.41 | g |
| Water to make | 1 | kg in total |

The processing solution having the above composition in an amount of 0.3 g was filled in a container capable of rupturing by pressure.

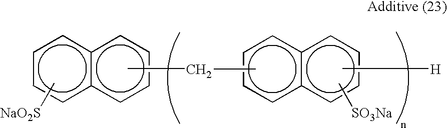

A color diffusion transfer photographic unit (sample No. 201) was prepared using the light-sensitive sheet 201, the cover sheet 201 and the processing solution (alkaline processing composition) 201 in accordance with the method disclosed, for example, in JP-A-7-159931.

Further, color diffusion transfer photographic units (sample Nos. 202 to 207) were prepared in the same manner as the sample No. 201, except that the total coating amount of silver halide and the amount of the nondiffusing reducing agent, defined in the present invention, incorporated in the color-mixing prevention layers were changed as shown in Table 2. Herein, the coating amounts of silver halide used in the 6th, 10th and 14th layers of each sample were changed uniformly at the same rate. In addition, the coating amounts of the nondiffusing reducing agent in the 7th and 11th layers as the color-mixing prevention layers were changed uniformly at the same rate.

In addition, sample Nos. 208 and 209 were prepared in the same manner as the sample No. 201, except that the silver halide emulsions used were changed as shown in Table 3, respectively.

The following evaluations were performed on the thus prepared samples.

(1) Black Depth

Uniform white-light exposure was applied to each of the samples obtained, and then a developing processing was performed at 25° C. After a lapse of one day, the depth of the maximum color-formation density was rated according to the following criterions. ◯: Black yielded was sufficiently deep, and black depth was at a satisfactory level. Δ: Black yielded was somewhat lacking in depth, and black depth was at a slightly troubled level. X: Black yielded was decidedly inferior in depth, and black depth was at a troublesome level.

(2) Color-Mixing Level

Patch-pattern exposure using LED devices emitting blue light, green light and red light, respectively, was applied to each sample while changing stepwise the quantity of each light, and then a developing processing was performed at 25° C. After a lapse of one day, the color-mixing levels of yellow-, magenta- and cyan-forming areas were evaluated by visual observation according to the following criterions. ◯: Color-mixing was little observed, so it was at a excellent level. Δ: Color-mixing was somewhat observed, so it was at a slightly troubled level. X: Color-mixing was observed clearly, so it was at a troublesome level.

(3) Image Formation Time

Each of the samples prepared was subjected to uniform exposure in the minimum light quantity capable of providing the maximum black formation density by means of the LED devices emitting blue-, green- and red-lights, respectively, and then to developing processing at 25° C. The time lapsed from the start of the developing processing until appearance of an image was recognized by visual observation was measured with a stopwatch.

The characteristics and evaluation results of each sample are shown in Tables 2 and 3.

TABLE 2

| | Coating amount of | Coating amount of | Mol ratio of silver | | | | |
|---|---|---|---|---|---|---|---|
| Sample | silver halide in terms | nondiffusing reducing | halide to nondiffusing | Black | Color- | Image formation | |
| No. | of silver (g/m²) | agent (mol/m²) | reducing agent | depth | mixing level | time (sec) | Remarks |
| 201 | 0.77 | 1.07E−03 | 6.69 | ◯ | ◯ | 9.2 | This invention |
| 202 | 0.77 | 2.13E−03 | 3.34 | X | ◯ | 14.5 | Comparative example |
| 203 | 0.77 | 5.34E−04 | 13.38 | ◯ | X | 8.9 | Comparative example |
| 204 | 0.54 | 1.07E−03 | 4.68 | Δ | ◯ | 12.4 | Comparative example |
| 205 | 0.54 | 7.47E−04 | 6.69 | ◯ | ◯ | 8.5 | This invention |
| 206 | 1.54 | 2.13E−03 | 6.69 | ◯ | ◯ | 13.1 | Comparative example |
| 207 | 1.54 | 1.07E−03 | 13.38 | ◯ | X | 10.5 | Comparative example |
| 208 | 0.77 | 1.07E−03 | 6.69 | ◯ | ◯ | 9.8 | This invention |
| 209 | 0.77 | 1.07E−03 | 6.69 | ◯ | ◯ | 10.3 | This invention |

TABLE 3

| Sample | | | Kind of | | Average sphere- | Average |
|---|---|---|---|---|---|---|
| No. | Layer No. | Sensitivity for colors | emulsion | Grain shape | equivalent diameter (μm) | aspect ratio |
| 201 to | 14th layer | Blue-sensitive layer | J | Hexagonal tabular grains | 0.63 | 11.0 |
| 207 | 10th layer | Green-sensitive layer | K | Hexagonal tabular grains | 0.63 | 11.0 |
| | 6th layer | Red-sensitive layer | L | Hexagonal tabular grains | 0.63 | 11.0 |
| 208 | 14th layer | Blue-sensitive layer | J2 | Hexagonal tabular grains | 0.63 | 7.2 |
| | 10th layer | Green-sensitive layer | K2 | Hexagonal tabular grains | 0.63 | 7.2 |
| | 6th layer | Red-sensitive layer | L2 | Hexagonal tabular grains | 0.63 | 7.2 |
| 209 | 14th layer | Blue-sensitive layer | J3 | Hexagonal tabular grains | 0.91 | 10.0 |
| | 10th layer | Green-sensitive layer | K3 | Hexagonal tabular grains | 0.91 | 10.0 |
| | 6th layer | Red-sensitive layer | L3 | Hexagonal tabular grains | 0.91 | 10.0 |

The foregoing tables demonstrate effectiveness of the present invention. More specifically, only the samples Nos. 201, 205, 208 and 209 according to the present invention, wherein the silver halide/nondiffusing reducing agent ratio by mole was in the range defined in the present invention (e.g. from 5 to 10), and besides, the total coating amount of silver was in the range defined in the present invention, achieved both good black depth and color-mixing level, and, in these samples, the image formation time was 10.3 seconds or below. By contrast, the sample Nos. 202, 203, 204 and 207, wherein the silver halide/nondiffusing reducing agent ratio by mole was out of the range defined in the present invention, were unsuccessful at achieving both good black depth and color-mixing level. In addition, it was found that the sample No. 206, in which the coating amount of silver was beyond the scope defined in the present invention, had a problem of suffering a delay in image formation. When an attention is paid to the silver halide emulsions used in the samples were made with the sample Nos. 201, 208 and 209, it was found that the image formation time of the sample No. 201 prepared using the emulsion comprising emulsion grains having preferred average sphere-equivalent diameter and average aspect ratio was shorter than those of the sample Nos. 208 and 209. Accordingly, the foregoing tables further indicate that the use of tabular grains high in aspect ratio and proper in grain size is advantageous.

### Example 2

It was confirmed that the same effects as in Example 1 were achieved also in the case where the exposure performed for evaluations of the foregoing samples was changed to a scanning exposure with organic EL devices emitting blue light, green light and red light.

Herein, the scanning exposure was carried out by scanning each light-sensitive sheet with organic EL devices in a lined arrangement in a direction vertical to the lined array of the organic EL devices, while applying voltages modulated based on the image information digitized in advance.

Having described our invention as related to the present embodiments, it is our intention that the invention not be limited by any of the details of the description, unless otherwise specified, but rather be construed broadly within its spirit and scope as set out in the accompanying claims.

What I claim is:

1. A color diffusion transfer film unit, comprising a light-sensitive sheet provided, on a first transparent support, with an image-receiving layer, a white reflecting layer, a light-shielding layer, at least three silver halide emulsion layers different in sensitivity for colors, and at least two color-mixing prevention layers containing a nondiffusing reducing agent, each of which is interposed between two layers among the three silver halide emulsion layers; a transparent cover sheet provided, on a second transparent support, with a neutralizing layer and a neutralizing timing layer; and an alkaline processing composition-containing material to be developed between the light-sensitive sheet and the transparent cover sheet:
wherein the silver halide emulsion contained in the light-sensitive sheet is a negative type silver halide emulsion; and
wherein a total coating amount of the silver halide is 0.9 g/m² or below in terms of silver and from 5 to 10 times greater by number of moles than a total coating amount of the nondiffusing reducing agent contained in the color-mixing prevention layers.

2. The color diffusion transfer film unit according to claim 1,
wherein silver halide emulsion grains in the light-sensitive sheet are tabular grains having an average sphere-equivalent diameter of from 0.2 μm to 0.8 μm and an average aspect ratio of 8 or more.

3. The color diffusion transfer film unit according to claim 1,
wherein the total coating amount of the silver halide is from 0.2 to 0.7 g/m² in terms of silver.

4. The color diffusion transfer film unit according to claim 1,
wherein the total coating amount of the nondiffusing reducing agent is from 0.5 to 1.5 mmol/m².

5. The color diffusion transfer film unit according to claim 1,
wherein the total coating amount of the nondiffusing reducing agent is from 0.8 to 1.2 mmol/m².

6. A method of forming an image,
wherein the color diffusion transfer film unit according to claim 1 is exposed to light by means of an exposure head emitting light at a plurality of wavelength regions in light quantity modulated based on image information.
